(19) United States
(12) Patent Application Publication
(10) Pub. No.: US 2010/0142755 A1
(43) Pub. Date: Jun. 10, 2010

(54) Method, System, and Computer Program Product for Providing Cosmetic Application Instructions Using Arc Lines

(75) Inventors: Ted J. Brandewie, Lexington, KY (US); Jerry D. Spry, Richmond, KY (US); Barry Nickell, Lexington, KY (US)

Correspondence Address: VENABLE LLP, P.O. BOX 34385, WASHINGTON, DC, 20043-9998, US

(73) Assignee: PERFECT SHAPE COSMETICS, INC., Lexington, KY (US)

(21) Appl. No.: 12/626,688

(22) Filed: Nov. 27, 2009

Related U.S. Application Data
(60) Provisional application No. 61/118,264, filed on Nov. 26, 2008.

(51) Int. Cl. G06K 9/46; G06T 7/00

(52) U.S. Cl. 382/100; 382/203

(57) ABSTRACT

Individuals want to look their best because when they look good, they feel good. It affects not only how they perceive themselves, but also how others perceive them. Unfortunately, many individuals don't look as good as they would like. And even more frustrating, they don't know how to produce their optimal facial look. Imagine a plain or average looking woman being able to transform herself into a very pretty woman. Imagine an already pretty woman being able to transform herself into a gorgeous woman. The Perfect Shape™ Makeover Process empowers individuals to achieve this magical transformation. Confidence, self-esteem, perception, and respect are enhanced in very positive ways. This is something individuals want on a universal, world-wide level. The Perfect Shape™ Makeover Process instructs the client how to use makeup to reshape each of these facial features to the ultimate of what they have to work with.

### CROSS REFERENCE TO RELATED APPLICATIONS

This application claims the benefit of U.S. Provisional Application No. 61/118,264, filed Nov. 26, 2008, entitled “Method, System, and Computer Program Product for Providing Cosmetic Application Instructions Using Arc Lines,” to Brandewie et al., the contents of which are incorporated herein by reference in their entirety.

### BACKGROUND OF THE INVENTION

1. Field of the Invention

The present invention relates generally to software and business methods and more particularly to service industry back-end automation.

2. Background Art

Most individuals don't look as good as the individuals would like. And even more frustrating, the individuals don't know how to produce the individual's optimal facial look. Individuals want to look their best because when the persons looks good, the person feels good. One's appearance affects not only how they perceive themselves, but also how others perceive them. When an individual's appearance is improved, confidence, self-esteem, perception, and respect are enhanced in very positive ways. These attributes are something all individuals want on a universal, world-wide level.

It is desirable for a client to appear the most attractive possible to both him/herself and others. What is needed is an improved system that may enable one to showcase attractive features by making the features more prominent, dramatic, and eye-catching. What is also needed is an improved system that makes less attractive features less noticeable. Thus what is needed is an improved system that enables one to be trained in application methods such that the positives are revealed and the negatives are concealed.

### SUMMARY OF THE INVENTION

The present invention sets forth various illustrative embodiments of apparatuses, systems, methods and computer program products for providing cosmetic application instructions using Arc Lines.

An illustrative embodiment may include a method of using one or more computers to receiving face and/or body data. The method may include using one or more computers to receive preference data. The method may include using one or more computers to calculate Arc Lines based on the face and/or body data. The method may include using one or more computers to analyze at least one of environmental, socio-economic, and/or seasonal factors. The method may include using one or more computers to determine one or more optimal cosmetic application procedures. The method may include using one or more computers to provide the optimal cosmetic application procedure.

The method may also include using the one or more computers to receive at least one facial feature to deemphasize. The facial feature to deemphasize may include a nose, eyes, lips, mouth, eyebrows, eyelashes, eyelids, ears, skin tone, forehead, a wrinkle, a wart, freckles, loose skin, a non-symmetrical feature, a crooked face, and/or one eye higher than the other.

The method may also include using the one or more computers to receive at least one facial feature to emphasize. The at least one facial feature to emphasize may include a nose, eyes, lips, mouth, eyebrows, eyelashes, eyelids, ears, skin tone, freckles, and/or forehead.

The method may also include calibration of a display device.

The face and/or body data may include skin tone, ancestry, eye color, age, and/or hair color. The face and/or body data may include measurements of face height, face width at cheekbones, nose height, forehead height, chin height, lips height, lips width, philtrum height, sublabial height, eye height, eye width, eye shadow height, brow up width, brow up diagonal length, brow down diagonal length, brow tip to hair height, brow tips width, face width at lips, face width at temples, and/or neck corner to collarbone height. The face and/or body data may also include measurements of height, age, and/or weight.

The preference data may include a type of look, time available, a geographic location, a time of year, a socio-economic class, a type of lighting, and/or a clothes color. The type of look my include natural, quick application, nightlife, glamorous, innocent, high fashion, seasonal style, stage, accenting eye color, goth, sexy, professional interview, professional daily wear, cat eye, a location style, and/or an personality style. The location style may include Hollywood, Paris, Milan, London, New York, San Francisco, Tokyo, Bombay, Munich, Vienna, and/or Rio de Janeiro. The personality style may include Bobbi Brown and/or Michael Maron.

Providing may include displaying, transmitting over a network, delivering a program product using a postal carrier, and/or hand delivery. Providing optimal cosmetic application procedure may also include content, video, audio, text, pictures, sketches, and/or audio/video media.

The method may also include receiving a photograph, a video clip, and/or a sketch.

The method may also include receiving data from a measuring device, a three-dimensional scanner, telephonically, the internet, a website, a photograph, a video, a picture, and/or a sketch.

The method may also include receiving a photograph, presenting photograph to at least one individual, and/or receiving data from said at least one individual.

The method may also include providing at least one proposed visual depiction of applied cosmetics and/or requesting and receiving approval or disapproval data.

Another illustrative embodiment may include a cosmetic instruction system which may include a processor which may be adapted to receive one or more face and/or body data; to receive preference data; to calculate Arc Lines; to analyze one or more environmental, socio-economic, and/or seasonal factors; to determine one or more optimal cosmetic application procedures; and/or to provide the optimal cosmetic application procedure.

Another illustrative embodiment may include a machine-readable medium that provides instructions, which when executed by a computing platform, causes the computing platform to perform operations which may include a method for creating cosmetic instructions, the method may include receiving one or more face and/or body data; receiving preference data; calculating Arc Lines; analyzing one or more environmental, socio-economic, and/or seasonal factors; determining one or more optimal cosmetic application procedure; and/or providing the one or more optimal cosmetic application procedure.

first, receiving client face and/or body data. Then receiving client preference data. Followed by calculating Arc Lines of the client. Then, the analyzing of environmental, socio-economic, and/or seasonal factors. Then, determining an optimal cosmetic application procedure. Finally, providing the optimal cosmetic application procedure to the client.

An illustrative embodiment may include a system that first, receives client face and/or body data. Then, it receives client preference data. Then it analyzes environmental, socio-economic, and/or seasonal factors. Then, it determines an optimal cosmetic application procedure. Finally, it delivers the optimal cosmetic application procedure to the client.

Yet another illustrative embodiment may include a machine-readable medium that provides instructions, which when executed by a computing platform, causes computing platform to perform operations comprising a method for creating cosmetic instructions. This method comprises first, receiving client face or body data. Second, receiving client preference data. Followed by calculating Arc Lines of the client. Then, the analyzing of environmental, socio-economic, and/or seasonal factors. Then, determining an optimal cosmetic application procedure. Finally, delivering the optimal cosmetic application procedure to the client.

The Perfect Shape™ Makeover Process empowers individuals to showcase attractive features by making them more prominent, dramatic, and eye-catching. Conversely, less attractive features are made less noticeable. Confidence, self-esteem, perception, and respect are enhanced in very positive ways.

The Perfect Shape™ Makeover Process specifies, for example, 12 different facial feature areas comprising an individual's face. The Process instructs the client how to use makeup to reshape each of these facial features to the ultimate of what they have to work with.

The Perfect Shape™ Makeover Process prioritizes natural looking shape with natural looking color. The reshaping process uses, for example, Highlights and Shadows that could be found on the face naturally. Color may be addressed by, for example, intensifying hues that could also be found on the face naturally. Perfect Shape™ makeup products use a limited spectrum of color hues providing, for example, natural looking colors for lipstick, lipliner, Blush, and eyelids. Each customer may be provided a custom designed application formula with natural looking color hues precisely matched to their skin tone. This combination of natural looking reshaping with natural looking color produces a magical change in perception of the individual's face.

Perfect Match™ may be defined as continuous, uniform makeup coverage without being noticeably visible. The Perfect Test™/Perfect Match™—Two Minors Outdoor Daylight Test determines the most appropriate shade of Foundation. The natural outdoor daylight provides the most unforgiving lighting standard to determine if the match of the Foundation shade with the skin tone is indeed natural looking. The objective may be to select the Foundation makeup shade that matches one's natural skin color and shade, with continuous coverage, yet without being noticeably visible.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention may be apparent from the following, more particular description of illustrative embodiments of the invention, as illustrated in the accompanying drawings. In the drawings, like reference numbers generally indicate identical, functionally similar, and/or structurally similar elements. A preferred illustrative embodiment is discussed below in the detailed description of the following drawings:

FIG. 1 depicts an illustrative embodiment of example Arc Lines and example positions of measurement;

FIG. 2 depicts an illustrative embodiment of measurements for an example Cat Eye Effect;

FIGS. 3A-3D depict several illustrative embodiments of example foam cosmetic applicators (e.g., foam wedge and flat foam stick) and illustrative hand positions which may be used for the application of cosmetic as may be instructed to a user by an exemplary system according to an example embodiment of the present invention;

FIG. 4 depicts an illustrative embodiment of an example computer system that may be used in implementing an illustrative embodiment of the present invention;

FIG. 5 depicts an illustrative embodiment of an example software design architecture;

FIG. 6 depicts an illustrative embodiment of an example client control view flowchart; and

FIG. 7 depicts a high-level view of anillustrative embodiment of an example Perfect Shape™ distribution system according to an example embodiment of the present invention.

### DETAILED DESCRIPTION OF THE INVENTION

An illustrative embodiment of the invention is discussed below including a preferred embodiment, as well as various other illustrative, but non-limiting embodiments. While specific implementations are discussed, it should be understood that this is done for illustration purposes only. A person skilled in the relevant art can recognize that other components and configurations may be used without parting from the spirit and scope of the invention.

Aspects of the Perfect Shape™ Process

The Perfect Shape™ Makeover process according to an example embodiment of the present invention, has been trademarked as Shapeover™. In an illustrative embodiment, the Perfect Shape™ Makeover or Shapeover™ system, method and computer program product may be used to guide a user in reshaping facial features and may follow principles such as, e.g., but not limited to:
1. Each individual has unique Arc Lines.
2. Arc Lines are precisely located.
3. Arc Lines define boundaries where facial feature areas are reshaped.
4. Reshaping involves the complementary contrast of Highlight and Shadow at the Arc Lines.
5. Natural appearing colors make the reshaping appear to be natural as well.

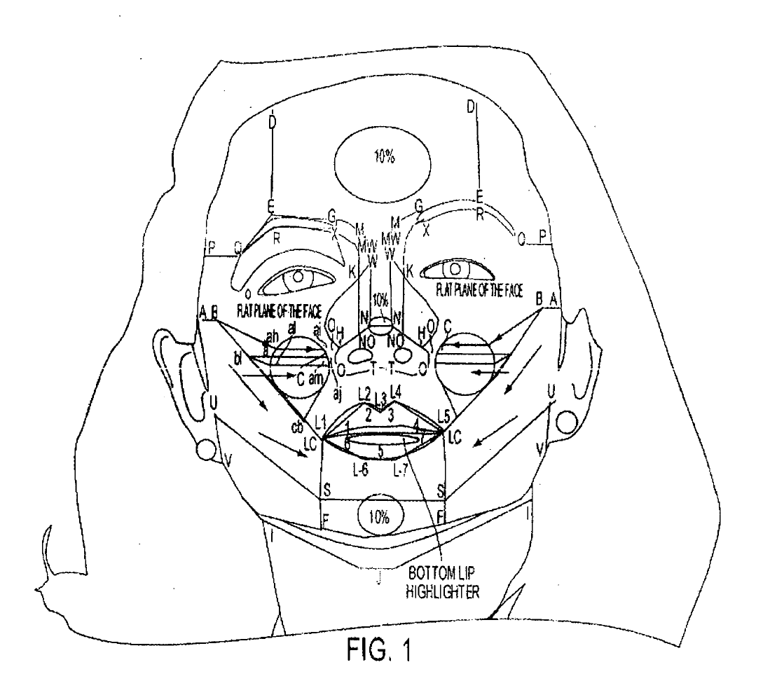

Arc Lines, such as those illustrated in FIG. 1, may be precisely located and unique to an individual's face. Unique Arc Lines may be determined by, for example, but not limited to, a three-dimensional scanner and proprietary software or, in another illustrative embodiment, by machine interaction with a customer to locate the customer's specific Arc Lines. Formulaic Arc Lines may be placed based on feature points. Perfect Shape™ Cosmetics of Lexington, Ky. provides, for example, an instructional, interactive computer based application, which may in an example embodiment be a digital versatile disk (DVD) video along with an example application formula custom designed for that specific customer based on that customer's Arc Lines, as described below.

The process may involve identifying the intersection of two planes. When two planes intersect, an Arc may connect one plane to the other. Since such so-called planes may actually be often not planar, but may be actually curvilinear planar in three dimensions, an Arc may be the transition from one substantially planar surface to another substantially planar surface. The Apex of an Arc may be halfway in the angular transition, as opposed to a distance transition, from one substantially planar surface to another substantially planar surface. The Arc Line may be the line that connects and/or may be the intersection of, e.g., all the adjacent center Apex points. Arc Lines can be vertical, horizontal, diagonal, and can curve. Arc Lines may trace the curvature when changing from one plane to another.

The Arc of the Covenant may be an Arc Line where an illusion of depth begins or ends. The word Covenant comes originally from a literal “coming together.” The Arc of the Covenant defines where two planes “come together” or convene and an illusion of depth may be created.

Many individuals perceive faces in only two dimensions—height and width. Comprehensive perception includes the dimension of depth, i.e., at least three dimensions. Depth creates shape and the illusion of depth may control shape. Reshaping the facial features of a customer using, for example, instructing the proper use of the contrast of makeup Highlights and Shadows may create the illusion of depth.

As a result of an optimal application, according to an example embodiment, Highlights may appear to come toward the viewer. Similarly, Shadows may appear to go away from the viewer. Depth may appear to come toward or away from the viewer. Depth may be enhanced, for example, by this contrast between Highlights and Shadows. The Highlight may emphasizes an area by reflecting the light. The Shadow may de-emphasizes an area by reducing the reflection of light.

Exemplary Arc Lines may define where depth may begin and end. The example embodiment of the Arc Lines and Arc of the Covenant concepts describe where the illusion of depth may be created and the boundaries between features may be established.

FIG. 1 depicts an illustrative embodiment of example Arc Lines and example positions of measurement of an example customer's image and is described in more detail below.

Cheekbone. Illustrative embodiment FIG. 1A-B may be along the farthest protruding part of the cheekbone. Illustrative embodiment FIG. 1 A horizontally may be at the front of hairline/sideburn. Vertically, illustrative embodiment FIG. 1 A, may be located on the Arc Line, which may be halfway in the angular transition from where the temple sinks in next to the eyes, the cheekbones stick out, and the hollows of the cheeks sink in. Illustrative embodiment FIG. 1 B may be the farthest protruding point of the cheekbone, halfway between side plane and the front plane of the face.

Illustrative embodiment FIG. 1 B-C may be determined by analysis of a customer smiling. On each side of the face, illustrative embodiment FIG. 1 C may be located vertically at the point approximately halfway between the middle and top of the apple of the cheek and horizontally at a point that may be approximately halfway, again, in the angular transition, between the front and side of the apple of the cheek next to the nose.

Jaw. Illustrative embodiment FIG. 1 V may be the back of the jawbone, just below the earlobe. Illustrative embodiment FIG. 1 F may be substantially straight down from the corner of the mouth. Illustrative embodiment FIG. 1 V-F may be approximately halfway between the planes of the vertical side of the face and horizontally under the jawline.

Chin. Illustrative embodiment FIG. 1 F-F may be approximately halfway between the planes vertically at the front of the chin and horizontally under the chin.

Neck. Illustrative embodiment FIG. 1 I-J may be approximately halfway between the more horizontal part under the jawline and the more verticle part of the neck below.

Eye Orbit/Nose. Illustrative embodiment FIG. 1 G may be the top part of the brow close to the nose. Illustrative embodiment FIG. 1 M may be the approximately halfway point in the approximately, but not limited to, 90 degree turn G-M-W and where the vertical front transitions to the plane inside the eye orbit socket and the side of the nose down to W. Illustrative embodiment FIG. 1 N may be the approximate bottom point where the front plane of the nose transitions to the side plane.

Nose Bottom. Back edge of nose bottom: The vertical plane of the face transitions to the horizontal plane of the approximate nose bottom at illustrative embodiment FIG. 1 O-T-T-O.

Front edge of nose bottom: The vertical planes of the nose transitions to the approximate horizontal plane of the nose bottom at illustrative embodiment FIG. 1 O-o-No-N-N-No-o-O.

Lips. The following example Arc Lines on the lips' outside edge go from the vertical plane of the face to the more horizontal plane of the lips:

Upper Lip. Illustrative embodiment FIG. 1 L1-L2 may be from the corner of the mouth to the first peak of the upper lip (labeled 1).

Illustrative embodiment FIG. 1 L2-L3 may be from the first peak of the upper lip to the valley of the upper lip (labeled 2).

Illustrative embodiment FIG. 1 L3-L4 may be from the valley of the upper lip to the other peak of the upper lip (labeled 3).

Illustrative embodiment FIG. 1 L4-L5 may be from the peak of the upper lip to the adjacent corner of the mouth (labeled 4).

Lower Lips. Illustrative embodiment 100 L5-L7 may be the corner of the left lip to the bottom lip's centerline (labeled 7).

Illustrative embodiment FIG. 1 L7-L6 may be the bottom center lip line (labeled 5).

Illustrative embodiment FIG. 1 L6-L1 may be the bottom center right outline back up to the right corner of the mouth (labeled 6).

Example Formulaic Arc Lines.

Temple. In an example embodiment, the Arc Lines of the temple may include the boundary of temple, above the peak of the arch of the brow. The temple may include D-E and P-Q in the illustrative embodiment FIG. 1 from E and vertically up to the hairline at D, and from the outermost tip of the eyebrow Q horizontally over to the hairline at P.

Eyebrows. In an example embodiment, the Arc Lines of the eyebrows may include the substantially straight lines of illustrative embodiment FIG. 1X-R and G-E; G-X may be longer than E-R. Illustrative embodiment FIG. 1E-Q and R-Q may be substantially straight lines as well which may taper to and intersect at Q: G-X-R-Q-E-G may collectively represent an exemplary eyebrow.

Below Mouth Corner dropping straight down. In an example embodiment, the Arc Lines below the mouth may include where the chin and the side of the face meet; where cheek Shadow meets the face below the lips: illustrative embodiment 100 LC-S-F.

Cheek bottom shadow boundary. In an example embodiment, the Arc Lines of the cheek bottom shadow boundary may include the ear opening to approximately two-thirds of the way down to the chin from the corner of the mouth: illustrative embodiment FIG. 1U-S.

The Perfect Shape™ Law of Color

The Perfect Shape™ Law of Color states that one should never apply a color of cosmetics not found on human skin naturally. Corals, blues, greens, and purples, for example, are colors of cosmetics that are not natural to the skin. These colors may be used to make a fashion statement but may be poisonous to a natural look.

The following colors, for example, are the only cosmetics colors (with the exception of, e.g., Foundation, Highlight, and Shadow) that should be used by a customer to achieve a natural look:
1. Blush may be a pale color of blood.
2. Lipstick may be a matching color hue of blood, but lighter than the Blush.
3. Lipliner may be same color hue as blood, but darker than the Blush.
4. Eyelid color for blue or green eyes may be a frosty or matte light lavender.
5. Eyelid color for brown eyes may be a frosty or matte light copper.
6. Eyelid color for hazel eyes that are warm tones, in which the brown exceeds the yellow, may be a light copper. For hazel eyes that are warm tones, in which the yellow exceeds the brown, the eyelid color may be light yellowish tinted light copper. For hazel eyes that are cool tone, in which the dominant colors are blue and green, the eyelid color may be frosty or light lavender.

The color for Blush looks completely natural because it may be based on the color of blood. Blood may be what produces the natural looking Blush on everyone. When a child or adult blushes, this color reflects the hue of blood in a lighter shade, because blood itself fills the apple of the cheek.

It may not be possible to shape with color nor may it be possible to color with shape. For example, using Blush to do shaping looks obvious and unnatural. Shape and color are diametrically opposed and yet complimentary at the same time. Each of shape and color needs the other not to be noticed individually but to complement the effect of the other. The same may be true about Highlights and Shadows. Highlight may be a makeup much lighter than the base Foundation. Highlight may be used to make the surface of the face appear to rise up or outward. Shadow may be a brownish gray makeup that may be much darker than the base Foundation makeup and may be used to create a shadow effect on the surface of the skin. The relationship of Highlight and Shadow creates the appearance of depth.

Customization Questions

An example embodiment of a general process is discussed further below. The client may be interactively prompted by asking key questions via an interactive electronic form questionnaire which may include an online computer application program, on the internet, a standalone computer application, a DVD-program, etc. to customize the process; the customer may thereby obtain her optimum look. The questions which may be presented to the user for response via, e.g., but not limited to, a browser based application, may include, but are not limited to:

1. Age of client: If the client enters data that shows she is younger, say less than 20 years old, the wrinkle minimizing tips, for example, may not be included in the customized instructional video. Entering an older age may cause wrinkle covering tips to be included as well as, for example, but not limited to, tips for highlighting shadows on the neck where wrinkles may often be severe, especially with thinner women who used to be heavier. Instructions for highlighting of naturally undesirable shadows, such as a turkey neck shadows, may be included in electronic instructions displayed/provided by the computer to the user in the form of exemplary instructions when highlights are being done. Instructions for using glycerin serum, for example, on heavy wrinkles before Foundation may be included as well.

An illustrative example of instructions that could be provided using and exemplary embodiment of the invention, could instruct, e.g., a) apply Foundation with the grain of the wrinkle; across makes the wrinkle more prominent; b) Apply Highlight with the grain and in the base of the wrinkle with, for example, a 1/32″ to 1/16″ tapered brush; and c) Apply Foundation more thinly around the eyes on older women so Foundation does not fill in and accentuate the wrinkles, etc.

2. History of Sun Exposure: Those answering that they have had years of heavy sun exposure may be presented with instructions including steps to minimize, for example, age spots and wrinkles.

3. Race/Ethnic Origin problems to solve: An example system may interactively receive responses including displaying options which may be provided if, for example, the individual believes the individual's nose may be too small or large, or if their lips are too thin or thick. Individuals with very fair skin or flat appearing faces may need more detailed instructions on how to create sculpted features. Some individuals may need individualized steps to minimize overly prominent lips and noses as well as different shades of Highlight. Shadow does not work as well on already very dark skin. If, for example, the individual wishes to minimize the size of their lips, then the lip liner may nee to be adjusted to go on the inside of the lips, giving the illusion of smaller lips. Typically, for example, highlights for lighter skinned individuals may be commonly known as shade #40.

4. Skin Tone: Skin tone fore a given individual may change over different areas of the individual's skin, for example, the Foundation, Shadow, and Highlight, especially at the extremes of black and fair skin. Thus an example system may instruct the individual which tone of make up to apply. For example, lighter skin may change the Shadow depth of gray, while darker skin may change the intensity of the Highlight. Almost all Caucasians and Hispanics, for example, may use #40 for Highlights and Charcoal Satin Shadow. Many African Americans, for example, may use shade #41 or, less frequently, shade #40. For example, Charcoal Satin Shadow may be often used. For women with very fair skin, for example #40 Foundation, then Hip bone or Toast should be used for Highlights.

5. Eyelid Color: The eye (iris) color determines the color of the eyelid color; hazel may be the most difficult to match and follow up questions may be asked for those women that have hazel eyes, in an example embodiment.

6. Measurements and resulting instructional video: Measurements may be taken of a variety of features that may be used to select portions of pictures and videos, for example, that may be compiled together to create, for example, an instructional interactive video application that may, when displayed to the user appear very similar to the client's face.

The Perfect Shape™ Makeover Process

1. Preliminary Steps:

A. Skin Type determination. Whether the facial skin is oily, normal, or dry may be determined by testing after the skin is washed with, for example, facial soap. If the skin becomes oily all over within, for example, 7 hours, the skin may fit the oily classification and no moisturizer may be instructed to be applied in step B. below. The T zone often is oilier; the top of the “T” zone is the forehead and the “T” continues down around side of nose. If the “T” zone is oily after, for example, 7 hours, the skin is partially oily and the 30 second test used below in non T zone areas. If no area of the face is oily after, for example, 7 hours, the skin may be average and 60 seconds may be used below. If the skin feels tight after washing with a cleansing cream soap, such as Dove, the 60 second test may be used below.

B. The 30/60 Second Grab Test. Start with skin that is clean and not yet moisturized. The “30/60 Second Grab Test” determines the proper amount of moisturizer. Apply moisturizer evenly, wait approximately 30 seconds for normal skin and approximately 60 seconds for dry skin. Then rub the back side of the hand across the applied area and sense the amount of friction. A very slight grab is perfect. If there is no grab, there is too little moisturizer applied. If the back side of the hand slides as if oil exists on its surface, then too much moisturizer was applied. If “T” zone oiliness is present during the day, apply less moisturizer to those areas and then test with the back of the hand after approximately 30 seconds. If the skin is really oily, instructions may be provided directing the user that additional applications may be required. Requiring additional applications may necessitate a larger supply of foam sticks and foam to be sent to the client.

C. Perfect Test™/Perfect Match™—Two Minor Outdoor Daylight Test. The goal may be to achieve a perfect match of the makeup Foundation with the skin color/tone/hue. Perfect Match™ may be defined as continuous uniform makeup coverage without being noticeably visible. Perfect Match™ may be achieved, for example, by taking sample Foundation makeup shades into natural outdoor daylight with two hand held mirrors. Here may be the Perfect Test™ technique: The first step may be to determine the color and shade of makeup that most closely matches, for example, the face and neck skin. The shade of makeup on the printed selection sheet that may be closest to matching the skin may be then applied to the Cheek and Neck areas.

The test may be performed in the following exemplary, but non-limiting manner. The individual may be sitting upright in a chair holding a mirror in each hand. The first minor may be used to check the Foundation match from the front view of the face. The second mirror may be held at the side of the face and may be used to check the Foundation match from the side view. The two minors may be slightly rotated toward each other until the side view of the face may be seen in the front mirror. What may be visible to the individual may be the side of the face viewed from the side. In the situation where the face is one color, the neck is another color, and the upper chest is still another color, the three may be averaged for a shade of Foundation that is a good blend.

The natural outdoor daylight, for example, may provide the most unforgiving lighting standard to determine if the match of the Foundation shade with the skin tone may be indeed natural looking.

2. Foundation (in One Illustrative Embodiment a 3 Sided ⅞″ Foam Wedge May be Instructed to be Used)

A. The purpose of the Foundation makeup may be, for example, to even out the consistency of the skin tone. As people age, the consistency of the skin tone may go from very even to uneven. The Foundation may restore the even consistency of youthful skin.

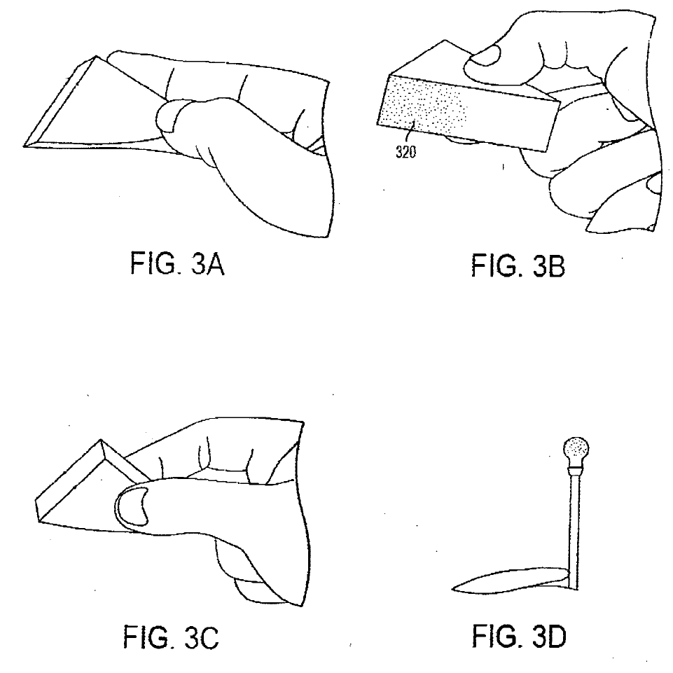

B. Once the skin of the face and neck pass the 30/60 second grab test, in an illustrative embodiment, Perfect Match™ mineral Foundation may be instructed to be applied. Perfect Match™ Foundation may be instructed to be applied with, for example, a 3 sided foam wedge. To load any foam wedge, the client may be instructed to hold the foam wedge as shown in an illustrative embodiment FIG. 3A, with the thumb and middle finger on the sides and the index finger on top. Loading a wedge means stroking the wedge on the Perfect Match™ Foundation until the foam may be saturated on the application area, which may be the top ½ of the longest flat surface, as shown in an illustrative embodiment FIG. 3B. Saturation may be determined, for example, by turning the foam over and not being able to see any uncovered area on the application area 320. For a lighter or thinner coverage of Foundation, the first stroke may be instructed to be made on the back of the hand to offload the heaviest coverage. Then, for example, a test stroke made on the forearm to see how much makeup is going on, and then the wedge may be instructed to be stroked on the face. When using a foam wedge or stick, the foam may be instructed to be always dragged, never pushed. Only use approximately 3 strokes on the face before reloading with approximately 3 strokes. Perfect Match™ Foundation may be applied to the entire face and the neck tapering down to nothing approximately ½″ to ¾″ below the illustrative embodiment of FIG. 1 I to J to I line. For a lighter saturation, for example, 4 or 5 strokes can be used against the skin, or, for an even lighter saturation, a brush, for example, may be used.

C. While the client is smiling slightly to stretch the wrinkles out of the lips, Blistex,™ or a similar product, may be instructed to be applied liberally to the lips now, early in the makeup process. This may give the excess Blistex,™ or similar product, time to soak into the lips.

3. Highlight (in one illustrative embodiment a 3 sided ⅞″ foam wedge may be instructed to be used)

A. Cheekbones.

The purpose of reshaping the Cheekbones may be to make them appear more prominent by appearing higher and wider.

For loading the Highlight, the wedge may be instructed to be held just like it was for the Foundation, as shown in an illustrative embodiment of FIG. 3A. Loose powder may be again cleaned off with approximately 1 stroke on the back of the hand. Next, on a different spot on the back of the hand or the forearm, for example, the wedge may be stroked to test whether too much or too little Highlight may be applied. If there is too much, the Highlight may appear powdery from particles being on top of one another; too little, and the color won't be the same as that in the pressed powder compact. The wedge is now held, for example, with the thumb again on the side, but, in contrast to how the wedge is held for applying Foundation, the index finger is on the side of the wedge, as shown in illustrative embodiments FIGS. 3B and 3C. With the individual's cheeks sucked in, Highlight may be instructed to be applied with, for example, the foam wedge achieving approximately 50% color shift from the Foundation/skin to the Highlight. The wedge may be pinched between the thumb and index finger, as shown in an illustrative embodiment of FIG. 3B. Without starting with the sharp front point of the wedge, which would result in an abrupt line on the face, the Highlight may be applied at point A in illustrative embodiment FIG. 1. The cheeks are sucked in to show more clearly the cheekbone. The wedge may be dragged over the Cheekbone centered from Arc Line FIG. 1A-B. The wedge may be then turned to FIG. 1 ah and then to ai. Wedge pressure may be lessened until approximately a 0% color shift at FIG. 1 ai. With the fingertip, blend the Highlight to the top boundary and to the middle line FIG. 1 al-am.

B. Upper Apple of the Cheeks.

For the Upper Apple of the Cheeks, the boundary is shown in illustrative embodiment FIG. 1 B-ah-ai-aj-am-al-bl-B. The cheeks are no longer sucked in, but rather a smile may be maintained. The strokes are made, for example, vertically, moving from the outside inward, with approximately 20% of the pressure as the Foundation. When there are smile wrinkles, they are filled in with the grain of the wrinkles with no smile and the wrinkled area may be stretched a little to ensure the wrinkle Highlight may be consistently applied compared with the skin next to the wrinkle and blended with the finger.

C. Jawline/Chin Line.

The purpose of reshaping the Jaw Line/Chin Line is to make it appear more well-defined and contrast it to the Shadow below on the neck and the Shadow above in the hollows. The boundaries for the Highlight on the Jawline/Chin Line go from illustrative embodiment FIG. 1 U-S-F-V-U, and approximately two strokes are necessary for the Highlight. For the first stroke, load a wedge, for example, with 3 fingers as shown in illustrative embodiment FIG. 3A, until the foam has a solid color with no uncovered areas. Stroke loose powder off on the back of the hand. Apply, for example, with 2 fingers for a softer, gentler application of Highlight. The first stroke may be a downward stroke with the wedge between FIG. 1 U-V with enough pressure to make, for example, a 20% saturation on the skin. By this the facial skin changes color, for example, 20% of the way from the starting color of the Foundation covered skin to the Highlight pressed powder.

For the next stroke, a foam wedge, for example, may be loaded with Highlight, just as with the Foundation using 3 fingers as shown in illustrative embodiment FIG. 3A. For an initial use of the wedge, the wedge may be stroked enough times until the wedge may be saturated, i.e., no original foam wedge color may be visible in the area of application. This application area is, like the Foundation, approximately ½ of the way back from the tip of the wedge. Loose powder may be removed on the back of the hand. The intensity of the powder may be measured by testing on the forearm. Continuous tone on the foam without looking powdery on the skin may be the goal. The next stroke may be applied from illustrative embodiment FIG. 1 V to F to the chin point; the bottom of the wedge traces the Arc Lines 100 V-F-chin point.

The wedge, for example, may be reloaded, and the application may be repeated for the Arc Lines FIG. 1 V-F-Point on the other side of the face. The Highlight application along the Arc Line FIG. 1 V-F should never go above the formulaic Arc Line U-S and not go above the S-S line when highlighting the edge of the chin. Thus, the Highlight and Shadow should never overlap.

4. Shadow (Recommended ⅞″ Foam Wedge, for Example)

One purpose of reshaping the Sides of the Face may be to frame the Cheekbones between the Sides of the Face and the Temples. A further purpose may be also to frame the jawline between the sides of the face and the shadow under the jawline. The Cheeks are made to appear higher and more prominent, while the Cheek hollows appear to be deeper and more lean. The purpose of reshaping the area under the Jawline and Chin may be to make it more defined and frame the bottom part of the face. The shadowing below the jawline reduces the neck's fullness, especially with the contrast of the Highlight at and above the Arc Line on the jaw/chin line. If there may be a double chin, the reshaping may minimize it.

A. Upper Sides of the Face/Upper Transitional Area

In the same way the Highlight was, the foam wedge, for example, may be loaded with Shadow with 3 fingers, as shown in illustrative embodiment FIG. 3A, and loose powder removed on the back of the hand or forearm. The cheeks are sucked in. For application, the foam wedge may be held like it was for the Highlight, thumb and index finger on the outside edge and index finger approximately ½ the way down, as shown in illustrative embodiments FIGS. 3B and 3C. Just below where the Highlight fades out along the bottom of the Arc Line as shown in illustrative embodiment FIG. 1 A-B-C, the wedge may be gently stroked downward, with decreasing pressure, toward formulaic line U-S. The Shadow fades out due to the decreasing pressure as the wedge approaches U-S. Use a handheld minor, for example, to examine whether over or under-saturated. The starting point occurs below FIG. 1A, where the Highlight fades out, and equal starting pressure may be used below B. Staying below FIG. 1 B-bl-al-am, starting pressure may be decreased to nothing down at cb. Vertically, the Shadow in the hollows fades to nothing at the FIG. 1 U-S line.

B. Lower Transitional Area

The Highlight and Shadow should never overlap; overlapping would create an unattractive muddy graying effect. Therefore, the Shadow application should never go below the formulaic Arc Line FIG. 1 U-S and the Highlight never goes above U-S. The boundary for the Lower Shadow to Highlight Transitional Area may be identified as FIG. 1 U-S.

C. Bottom Part of Apples of the Cheeks

For the Bottom Part of the Apple of the Cheeks, while smiling the Shadow application may be made vertically with, for example, the foam wedge. Wedge pressure may be approximately 20% below FIG. 1 bl-al-am decreasing to approximately 0% at the bottom of the inverted triangle, point cb. Never let the Shadow go above FIG. 1 bl-al-am. Horizontally the Shadow on the bottom of the apple fades to nothing at FIG. 1 am.

D. Under the Jawline and Chin.

The top boundary line under the Jawline and Chin may be the Arc Line FIG. 1 V-F-F-V. The bottom boundary line may be the Arc Line FIG. 1 I-J-I.

The wedge, for example, may be reloaded and loose powder removed on back of hand or forearm. The wedge may be again held with the thumb and index finger on the outside edges, as shown in illustrative embodiments FIGS. 3B and 3C. A Vertical stroke starts just under the midpoint of Arc Line 100 F-F at, for example, 25% pressure compared to the approximately 100% pressure when applying Foundation. This should result in, for example, a 25% darkening shift from the Foundation to the Shadow pressed powder. The pressure may be decreased evenly for all these vertical strokes to, for example, 0% at the Arc Line FIG. 1 I-J-I. The starting vertical pressure may be decreased gradually as strokes are made on alternating sides of the face until, for example, 15% below FIG. 1 F. The wedge, for example, may be reloaded, loose powder removed, and approximately 15% beginning vertical pressure starting at FIG. 1 F and may be decreased gradually to approximately 5% under V on one side. Beyond FIG. 1 V, for example may be nothing. The wedge, for example, may be reloaded, loose powder removed, and approximately 15% starting pressure may be done on the other side. Strokes start below the FIG. 1 F-F line so it may be darker there than when the Shadow may be applied below FIG. 1 V, despite both starting at approximately 20% pressure.

5. Shadow Temples (Recommended, for Example, ⅞″ Wedge Foam)

A. The purpose of reshaping the Temples may be to make them appear to sink inward and thereby narrowing the appearance of the Forehead's width. Not only does this Shadow contrast with the lighter forehead, it especially contrasts with the Highlighted Cheekbones. All Shadows and Highlights get their relevant value from their contrasting neighbors. For this reason the final evaluation of lightness and darkness, Highlights and Shadows, cannot be determined until all are applied and viewed from the front for effect and from the side for natural looking shadow effect, though the test may next be done in the finishing touches step.

B. The boundaries of the Temples go vertically, as shown in illustrative embodiment FIG. 1 D-E, diagonally E-Q, horizontally Q-P, and ends along the hairline P-D. The Shadow may be loaded onto the wedge and any loose powder removed on the back of the hand or forearm. Starting at the FIG. 1 D-E line, the Shadow may be applied horizontally with the same consistency over to the hairline. The idea may be to fill this boundary in horizontally from the FIG. 1 D-E line to the hairline and diagonally along the E-Q line and horizontally from the Q-P line as evenly as possible. The Shadow may be blended around the edges using either the backside of the foam or a fingertip.

6. Shadow Nose (Recommended Flat Pad of the Foam Stick, for Example)

The purpose of reshaping the nose is to make it appear more narrow and less prominent. When applying Shadow anywhere on the nose, do not apply Shadow in any creases or indentations, as the Shadow makes the creases more prominent and therefore much worse.

The Shadow is loaded onto a flat foam stick pad, for example, in a circular motion and loose powder removed by blowing straight into the flat pad. When using a foam stick, the foam may be always dragged, never pushed.

A. Upper Sides of Sinus Cavity.

The wide part of the pad may be positioned across illustrative embodiment FIG. 1 G-X and moved lightly over and downward so that the top of the pad travels along the Arc line G-M-W-N and the bottom of the pad along X-K-No; the path terminates at Arc Line portion N-No. Enough Shadow should be applied so that the Shadow effect is, for example, 15% of the grey scale shift from the Foundation covered skin to the Shadow powder. The process may be repeated on the other side. The tip of the index finger may be used to blend the Shadow transitioning from Shadow to Foundation along the FIG. 1 X-K line.

B. Sides of Sinus Cavity.

The boundary of the Sinus Cavity, or side of the nose, may be FIG. 1 K-No-H-K. The pad may be not reloaded. Starting just outside FIG. 1 K-No line, the first stroke may be made parallel to this line even more gently than the first Shadow along the side of the nose X-K-No. At slightly lower pressure, another stroke may be made next to the previous stroke and another, may be made at slightly lower pressure next to that. The Shadow fades to nothing at FIG. 1 K-H. The finger tip blends along FIG. 1 K-H. This may be the transition line from the sinus cavity to the flat plane of the face; it may be not substantial enough to be an Arc Line on all faces. In other words, the Shadow on the side of the nose fades to nothing as it approaches the flat plane of the face under the eyes.

C. Under Bottom of Sinus Cavity.

The boundaries for the Bottom of the Nose go from Arc Line FIG. 1 O-T-T-O and O-o-No-N-N-No-o. The pad may be reloaded and loose powder removed. The Shadow may be applied for an approximate 15% coverage shift. The Shadow may be applied horizontally with the wide part of the flat foam pad covering inside the boundary area and blended around the edges with the index finger or the empty, opposite side of the pad.

7. Highlight Front Length of the Nose (Recommended Flat Underside of Pointed End of Foam Stick).

The boundaries of the Front Length of the Nose are as shown in illustrative embodiment FIG. 1 MW-W-N-N-W-MW-MW. The Highlight may be loaded onto, for example, a pointed stick by rubbing one side in the pressed powder and blowing straight into the foam side to remove any loose powder. When using a foam stick, the foam may be always dragged, never pushed. To steady the hand that may be holding the Highlight foam stick, the other hand may be made into a fist and the chin rested on the thumb and index finger. The hand holding the stick may be then rested on the back of the fist for a very steady platform. The stroke may be made downward with enough pressure for an approximate 10% color shift. This Highlight may be applied to the middle half between FIG. 1 W-W and N-N not to exceed, for example, ⅓ the width of the front of the nose. Except for the eyes, the face may be now properly contoured with Highlight and Shadow.

8. Shadow Eye Features (Recommended Pointed End of Double End Foam Stick).

A. The purpose of reshaping the Eyes may be to make them appear dramatically larger and deeper and therefore more attractive. This may be accomplished by establishing a continuous Shadow zone around each eye. This zone includes the top and bottom of the “Cat Eye” effect and continues up to the top of the eyebrows. Dramatic depth may be created by the contrast between the Shadow above the upper eyelid's crease and the much lighter eyelid. Depth may be further increased with the bottom half of the Cat Eye effect. The contrast between the dark Eyelashes and the lighter Eyelids may be dramatically noticeable for a more relaxed expression.

B. Top Frame of Cat Eye Effect

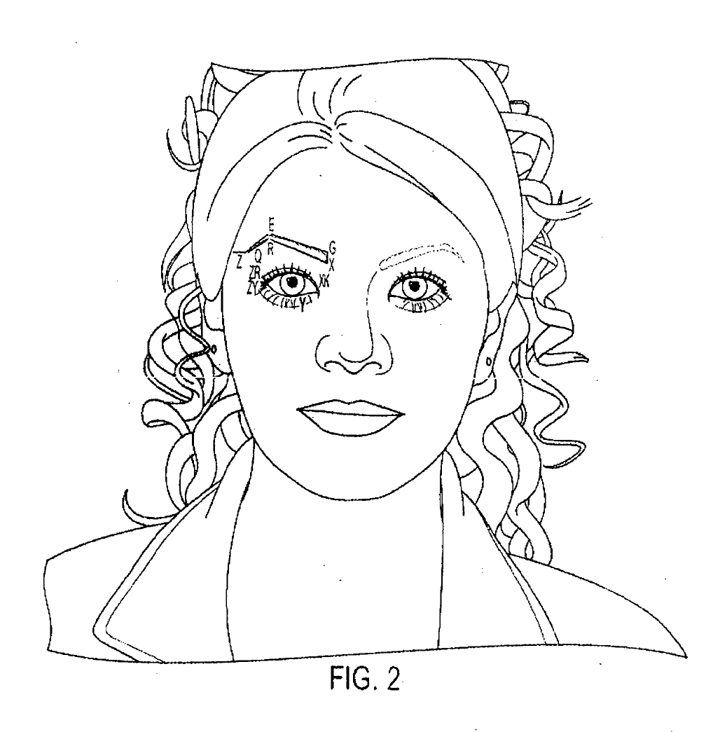

FIG. 2, depicts illustrative measurements for the Cat Eye effect. For the Top Frame of the Cat Eye effect, the boundary may be FIG. 2 XK-X, along the bottom of the eyebrow passing R-Q-Z and back to ZR and along the crease to XK.

The Cat Eye Shadow may be loaded onto the pointed stick by laying it nearly flat on the pressed powder and rotating the stick back and forth until the foam may be completely saturated all the way around the foam pointed applicator with no light spots. Loose powder may be removed by blowing straight into the point end tip. Do not be concerned with light spots on the surface after the loose powder may be removed, because the foam may be saturated below the surface.

Cat Eye Shadow must never mix with the next step's eyelid color or its Highlight, so Shadow may be never applied below the crease from FIG. 2 XK to ZR. To prevent this mixing, the crease must be clearly marked the first few times until the crease location may be learned. For the straight ahead look, crease marks are applied using the foam tip along the top edge of the crease. Starting above the inside edge of the iris, the colored portion of the eye, the marks are made at the top edge of the crease moving outward to the end of the crease at FIG. 2 ZR.

To obtain a fuller view of the eyelid including its crease, either the head may be tilted back slightly or a handheld minor, for example, may be held below and the eyes look down, without pointing the head down, to see into the hand mirror, for example. The previous crease marks should be visible; the crease line should be applied between the previous, “straight ahead” crease marks and the fold/wrinkle of the eyelid.

The pointed foam stick, for example, may be loaded by spinning back and forth for complete saturation and loose powder blown off with a burst of air straight into the tip. The Shadow may be applied at the inside of the eye halfway between the crease marks when the eyes are looking straight ahead and when they are looking down. This gap between the eyelid color and the eye Shadow may prevent mixing of the two powders, which would create an undesirable muddying effect. As shown in an illustrative embodiment in FIG. 2, the Shadow may be applied from XK-X line all the way over to and fading to nothing just before Z. The point may be then lifted back to the middle of the stroke and retraced to FIG. 2 Z to increase the saturation at the end of the stroke compared to the beginning of the stroke. The point may be rolled, for example, 180 degrees so the other side of the point applies the Shadow just above and all along the previous stroke, from the FIG. 2 XK-X line all the way over to Z. The first and second applications run parallel to the crease of the eyelid. The point may be again lifted back to the middle of the stroke and retraced to even out the saturation. The third stroke begins just above the second stroke but runs parallel to the bottom of the eyebrow, from the FIG. 2 XK-X line to Z; again, after the stroke, the point may be lifted up and retraced over, for example, the last half. The fourth stroke, for example, may be just above the third and may be parallel to the brow. The point may be again retraced over the last half, for example, of the stroke. If there are any gaps between the first two strokes running parallel to the crease and the last two tracing the eyebrow, they are filled in now.

To blend the upper nose Shadow with the eye Shadow, use approximately 5% pressure. Move the foam from inside to the outside along FIG. 2 X-XK, blending the nose Shadow with the Eye Shadow. A fingertip can alternatively be used to blend the side of the nose's Shadow with the Eye Shadow.

C. Bottom Frame of Cat Eye Effect.

FIG. 2 depicts an illustrative measurement of the bottom frame of the Cat Eye effect. The bottom of the Cat Eye Effect starts with loading the pointed foam stick and blowing off loose powder with a burst of air straight into the point tip. Starting at FIG. 2 Y and with approximately 20% pressure, Shadow may be applied with the tapered point. Pressure increases to approximately 50% at FIG. 2 ZY and at approximately 80% of the way from ZY to Z the Shadow begins to taper to approximately 0% pressure just before reaching Z. At FIG. 2 Z, use the index finger to fade to nothing.

D. Filling in the Cat Eye Gap.

The top and bottom Cat Eye Effect should be blended together. For a silky smooth finish, the entire process may be repeated. The pointed foam stick, for example, may be rotated to the other end, where the flat pad can then smooth out the entire surface, starting above the crease. The flat foam pad may be especially helpful when fading out at FIG. 2 Z. When using the flat foam pad, care must be taken to just smooth the Shadow and not to remove it.

E. Eyebrows.

Before shadowing the brow, it must be brushed up with the brush/comb tool in order to move the Foundation from the brows to the skin behind them. The brush/comb tool has a brush on one side and a flat, thin, fine, eyelash comb on the other side, both the brush and the comb are attached to a handle. The pointed foam tool may be loaded and loose powder removed by blowing straight into the tip. Shadow may be applied to the brow at approximately 15% pressure starting with an upward movement from FIG. 2 X-G and moving to E-R, where a subtle but sharp peak at E may be created. The stroke continues to FIG. 2 Q. Any light areas in the brow should be darkened to equal the other brow areas' darkness.

The upper and lower Cat Eye and the eyebrow are repeated on the other side. The brows are checked as follows to see if they are too long on either side, and trimmed on either or both sides as necessary. The eyelash comb pulls the brows up parallel to FIG. 2 G-E at one brow thickness above G-E; those eyebrow hairs that stick beyond the comb should be trimmed with miniature scissors above the comb. Make sure the comb may be a full eyebrow thickness above the top of the brow because the trimmed hairs may drop well below the trim line. The female brows should be brushed up and slightly backward because women's brows look more dainty and feminine pointing up. Men's brows look more functional and masculine pointing horizontally toward the tip of the brows.

9. Eyelids (Recommended Small, Singled Sided, Oval Shaped, Flat Foam Stick)

A. Upper Eyelid Color (Light Frosty or Matte—Specific to Eye Color).

The purpose of the eyelid color and its Highlight may be to make the lids and lashes contrast and thereby making the eyes look relaxed and communicative. The boundary of the Upper Eyelid Color area goes from the base of the Eyelashes up to approximately 90% of the way to the crease and over to each corner of the eye. Upper Eyelid Color can be frosty or matte; often frosty looks more dramatic and better, but the client can choose matte instead. The eyelid colors are always light. Eyelid color for blue or green eyes may be a frosty or matte light lavender. Eyelid Color for brown eyes may be a frosty or matte light copper. For hazel eyes that are warm tones, in which the brown exceeds the yellow, the eyelid color may be a light copper. For hazel eyes that are warm tones, in which the yellow exceeds the brown, the eyelid color may be light yellowish tinted light copper. For hazel eyes that are cool tone, in which the dominant colors are blue and green, the eyelid color may be frosty or light lavender.

The Eyelid Color may be loaded onto, for example, a flat oval foam pad in a circular motion and loose powder removed by blowing straight into the flat loaded pad. The color may be applied for an approximate 100% color shift i.e., the eyelid color may match the color of the pressed powder. The Upper Eyelid Color may be applied horizontally, starting at the side nearest the nose, from the eyelash line from one corner of the Eyelid to the other. The color may be applied with the top of the pad reaching approximately 90% of the way to the crease. The pad may be reloaded and loose powder removed by blowing directly into the flat oval foam pad. The same strokes are repeated for the other eye.

B. Upper Eyelid Highlight (Frosty or Matte Ivory on Top of Eyelid Color).

The upper Eyelid Highlight may be a frosty or matte ivory applied onto the center of the eyelid color. The other side of the short oval stick, for example, may be loaded with Highlight in a circular motion and loose powder blown off. The Highlight may be applied onto the middle third from left to right, and from the eyelashes up to ⅔, for example, of the way to the crease. The Highlight may be applied horizontally and heavily enough that the Highlight on the eyelid may be the same color as the pressed powder, or an approximate 100% color shift.

10. Eyelashes

The purpose of reshaping the Eyelashes may be to make the eyelashes more revealing by contrasting the dark eyelashes against the light eyelid color and its Highlight. This may be done, for example, by making the tips of the lashes raise up to the level with the crease of the Eyelid or higher.

A. Mascara Upper Eyelashes with Mascara Wand.

The mascara wand, for example, may be used to apply mascara to the Eyelashes. When the mascara wand may be twisted out of its holder, there may be usually an excess of mascara on the tip of the wand. The excess mascara must be removed. It may be removed, for example, by rubbing the tip of the wand against the opening of the mascara wand holder. Note that since mascara dries very quickly, it may be necessary to apply mascara and separate upper eyelashes one eye at a time.

B. Separate Upper Eyelashes.

The mascara may be applied to the upper Eyelashes with the mascara wand held, for example, horizontally and below the lashes. The wand may be then moved upwards from the roots to the tip of the lashes. Start in the middle, so the most mascara may be placed in the middle, and then move to the outside and then inside of the upper eyelashes. The Eyelashes are saturated with mascara. For even longer appearing lashes, the wand may be put on the backside of the upper lashes, again starting in the middle, going to the outside, and finishing on the inside. While applying mascara to the backside of the lashes, the wand may be pulled forward and spun with the bottom turning up. Using the mascara wand on the back side of the upper lashes can get messy if caution may be not used.

As the mascara dries very quickly, it may be necessary to separate the lashes one from another immediately before moving on to the other eye. The eyebrow/eyelash tool has a brush on one side and a flat, thin, fine eyelash comb on the other side. The eyelash comb may be inserted into the Eyelashes and lifted upwards from the roots to the tip of the lashes. The separation process may be repeated until all the lashes are separated. The apply and separate process may be immediately repeated for the other Eye, allowing the mascara to dry on the first eye for about one minute before the lashes are curled. So, the other lashes can have mascara applied and the lashes separated while the first lashes are drying. Do not let the lashes dry longer than approximately 1.5 minutes before curling. The mascara acts like a gel to make the lashes stand up.

C. Curl Upper Eyelashes with Eyelash Curler.

The Eyelash curler may be used to curl the Eyelashes. Before use, the Eyelash curler should always be cleaned with alcohol, or other similar solvent, at the metal and rubber bases to insure the curler does not pull lashes out. The Eyelash curler may be held with the thumb on the bottom handle and one of the middle fingers in the top handle. The curler may be opened and placed as close to the roots of the upper lashes as may be comfortable. The curler may be pressed down against the root of the upper lashes. Constant contact may be maintained with the lashes while repeatedly pumping greater and lesser pressure while counting backward from approximately 20 to 0, for example, for each pump of the eyelash curler. If the Eyelash curler may be not pumped repeatedly, the Eyelashes can stick to the curler and can be easily pulled out. If the tips of the lashes do not rise up to or above the crease of the eyelid, a second curling may be necessary. For the second curling, the curling tool may be engaged halfway between the roots and tips of the Eyelashes. Repeat the process for the other Eyelash. A second coat of mascara and separation may help the lashes appear thicker and longer.

D. Mascara Lower Eyelashes.

Mascara may be applied to the bottom lashes in much the same way as the upper eyelashes starting at the roots and going to the tips of the lashes, except the strokes are made downward.

E. Separate Lower Eyelashes.

Separate the lashes one eye at a time, as described above. Repeat the process for the other Eye. The bottom lashes are never curled with a curler.

11. Lips (Top and Bottom)

A. Blistex (or Similar Product)

The purpose of reshaping the lips may be to make them appear fuller and more well defined, thereby making them more attractive. The purpose of applying Blistex,™ or other similar product, may be four fold. First, it makes the lipliner go on much more smoothly. Second, it takes the creases out and thereby smooths the lips. Third, it fills in the lip tissue so the lipstick may not absorb into the lips as easily and thereby fade. Fourth, it may help keep the lipstick from flaking from dryness. If the lipstick starts to flake later, Blistex,™ or other similar product, may be applied over the lipstick. If more lip color may be needed after the Blistex,™ or other similar product, may be reapplied, lipstick may be reapplied over the Blistex,™ or other similar product.

Blistex,™ or other similar product, was already applied earlier in the process, directly after the Foundation application step. This gives the excess Blistex,™ or other similar product, time to soak into the lips. Wad up 3 tissues, for example, to form a blotter and lightly “kiss” the blotter to the edge of the lips. This may be done just before the lipliner may be applied. Do not blot the lips with tissue between the lips, as this removes too much Blistex,™ or other similar product.

B. Lipliner (with Mechanical Lipliner)

The mechanical lipliner is screwed out approximately ⅛^{th} inch and used to outline the lips. As depicted in an illustrative embodiment in FIG. 1, the Top Lip starts at point LC continuing through lines 1, 2, 3, and 4 to the other LC. The application may be made strictly along the lines, and may be not curved when they meet. Never push the pencil; always drag it. No smiling may be done during this step so the points are visible, especially on the top lip. If there are any wrinkles along the lip line which makes the initial application irregular, a slight smile helps smooth out those wrinkles for the second stroke. For the Bottom Lip, the application may be made first on line FIG. 1 5, which often has the same width as the distance between FIG. 1 L2-L4 above. Then the application may be made from FIG. 1 LC along line 6 to L-6, and then from L7 to the other LC.

C. Lipstick (Recommended Oval Pad Same as Eyelid)

Lipstick may be applied with a small single flat oval pad to both the Top and Bottom Lips. A slight smile with the mouth open wide stretches out any wrinkles, and the lipstick may be applied so it covers the space between the lines FIG. 1 1 through 7.

D. Highlight Lipstick (Other Side of Lipstick Pad)

The recommended pad to apply the Bottom Lip Highlighter may be the other side of the same pad used to apply the lipstick. The Bottom Lip Highlighter may be placed, for example, vertically two-thirds of the way up from the bottom edge of the bottom lip up to where the lips come together. Horizontally, the placement may be approximately centered with two-thirds of the width of the bottom lip across the bottom lip.

12. Finishing Touches

A. Blush (Recommended Narrow (½″) Foam Wedge)

The purpose of Blush may be to add natural looking color where it naturally best occurs. The boundaries are shown in illustrative embodiment FIG. 1 aj-a-bl-cb-aj. The ½ inch wedge, for example, may be loaded like the Foundation, Highlight, and Shadow, with the index finger at the back of the wedge, and the thumb and middle finger on the sides. The loose powder may be cleaned off by wiping on the back of the forearm, and the application amount may be tested by applying on another area of the forearm, for example. The color shift should be approximately 10% of the pressed Blush powder. The wedge may be held and applied horizontally being careful to avoid square tip of the wedge. The application area may be inset from all edges of the wedge. A smile helps puff out the cheeks to help show where the apple may be and the Blush should go. The first stroke starts at approximately 0% at FIG. 1 am, increases to approximately 10% halfway between am and al, continues at approximately 10% toward al, and decreases to approximately 0% at line bl-cb. The second stroke starts at approximately 0% color shift below the previous stroke, but peaks at approximately 7.5% color shift in the middle of the apple and fades to nothing when reaching the FIG. 1 bl-cb line. The third stroke may be similar, starting at approximately 0%, increasing at the apple's midpoint to approximately 5%, continuing horizontally to the other side of the apple, and then decreasing to approximately 0% at the line FIG. 1 bl-cb. Strokes continue with decreasing peak color shift until the bottom of the apple boundary cone FIG. 1 cb may be reached, where, for example, the Blush fades to nothing.

B. Perfect Test™/Perfect Shape™

The first few times the Perfect Shape™ process may be done, the Perfect Test™/Perfect Shape™ may be conducted outside in daylight before any finishing touches are applied in the next step. The Perfect Test™/Perfect Shape™ may be conducted outside using the same two mirrors as the Perfect Test™/Perfect Match™. This may be the single most important test. Highlights and Shadows are examined, and touch ups with for example, a foam wedge, back of a foam stick, or blending with a fingertip may be necessary to achieve a natural look. Adding or removing, for example, Highlights, Shadows or Blush may be necessary to blend. The viewer should ask, “Do the Highlights or Shadows look believable from a side view of 90 degrees?”. If there may be too much effect of a particular pressed powder, a clean wedge or foam stick, for example, can be used to reduce the excess; whatever tool type was used to apply, a clean tool should be used to reduce the effect If there are multiple areas needing to have Shadow removed, start with the lightest Shadowed areas, such as the temples or sides of the nose. If heavier areas are done first, the foam may carry excess Shadow that may be mistakenly applied to the lighter areas. When in doubt, use a fresh clean foam wedge or foam stick pad. Checking for a Perfect Match™ can be done without the second minor but not as well. However, the Natural Looking Shape Test™ can only be done with two minors.

C. Enhancing Natural Color (Recommended Very Light Dusting with Foam Wedge)

Color may be added to the overall skin tone by adding a very light dusting of Blush to the center of forehead, tip of the nose, and most forward part of the chin. These areas are shown in an illustrative embodiment in FIG. 1, with a label of 10%. The light dusting of Blush may be finalized with the application of Botanical Mist, or similar product.

D. Setting the Makeup with Botanical Mist

The purpose of the Botanical Mist, or similar product, may be to make the skin look less like powder and more like skin. The Botanical Mist, or similar product, may be applied approximately 12 inches from the face. First, the mister may be pumped while moving, for example, from the forehead to the chin, and repeated. Next, the mister may be pumped once moving horizontally from the outside edge of one eye to the outside edge of the other eye. The mist should be patted in with the hand to achieve a slightly more reflective surface to appear more like skin than powder. Also, a foam wedge, for example, can be loaded with moisturizer and tested on the forearm to see when blotting with the moistened foam may be not making obvious wet moisturizer on top of the makeup. Next blot lightly with the moistened foam wedge on top of the Foundation for even a greater reflectance for an even better, less powdery finish and pat in with the hand. The client should note that if she itches on the face, now or during the day, not to rub the itch as this may push shadow into highlight and vice versa. Rather, just poke straight in to relieve the itch if necessary.

Hardware

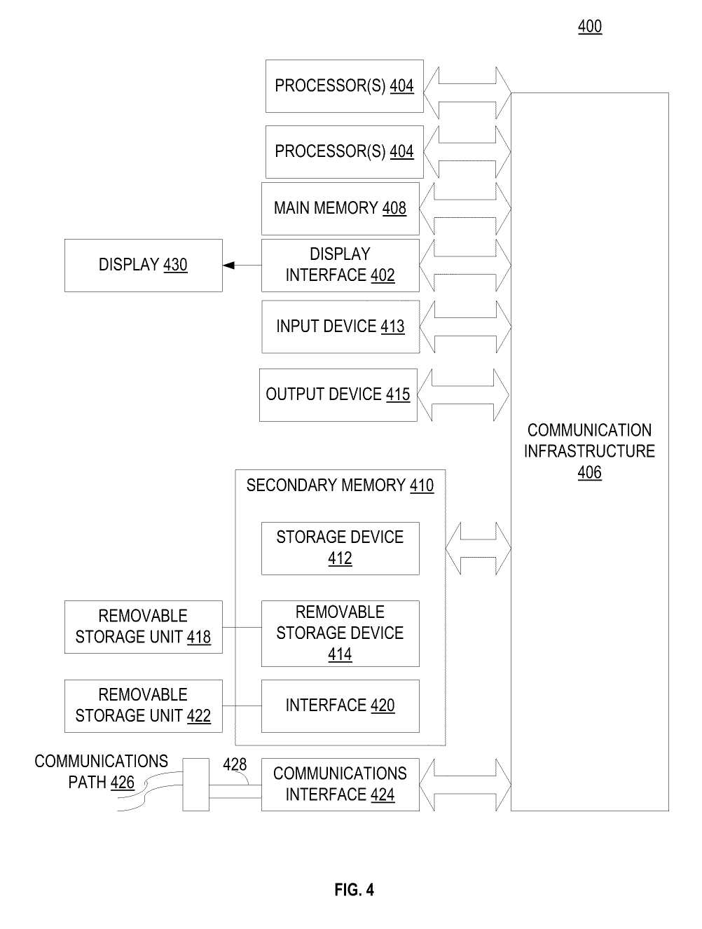

FIG. 4 depicts an illustrative computer system that may be used in implementing an illustrative embodiment of the present invention. In an example embodiment, a program may be provided on a DVD or BlueRay disk and the computer system may include, e.g., but not limited to, an online application server, a PC, or a DVD or BlueRay player which may insteractively prompt the user to enter responses to prompts, may analyze responses, and may provide instructions tailored based on the user responses.

Specifically, FIG. 4 depicts an illustrative embodiment of a computer system 400 that may be used in computing devices such as, e.g., but not limited to, client or server devices. FIG. 4 depicts an illustrative embodiment of a computer system that may be used as client device, or a server device, as part of an online multicomputer system, a standalone device or subcomponent, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 400 may be shown in FIG. 4, depicting an illustrative embodiment of a block diagram of an illustrative computer system useful for implementing the present invention. Specifically, FIG. 4 illustrates an example computer 400, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. However, the invention may not be limited to these platforms. Instead, the invention may be implemented on any appropriate computer system running any appropriate operating system. In one illustrative embodiment, the present invention may be implemented on a computer system operating as discussed herein. An illustrative computer system, computer 400 may be shown in FIG. 4. Other components of the invention, such as, e.g., (but not limited to) a computing device, a communications device, a telephone, a personal digital assistant (PDA), a personal computer (PC), a handheld PC, a laptop computer, a netbook, a video disk player, client workstations, thin clients, thick clients, a mobile device, a mobile phone, proxy servers, network communication servers, remote access devices, client computers, server computers, routers, web servers, data, media, audio, video, telephony or streaming technology servers, etc., may also be implemented using a computer such as that shown in FIG. 4.

The computer system 400 may include one or more processors, such as, e.g., but not limited to, processor(s) 404. The processor(s) 404 may be connected to a communication infrastructure 406 (e.g., but not limited to, a communications bus, cross-over bar, or network, etc.). Various illustrative software embodiments may be described in terms of this illustrative computer system. After reading this description, it may become apparent to a person skilled in the relevant art(s) how to implement the invention using other computer systems and/or architectures.

Computer system 400 may include a display interface 402 that may forward, e.g., but not limited to, graphics, text, and other data, etc., from the communication infrastructure 406 (or from a frame buffer, etc., not shown) for display on the display unit 430.

The computer system 400 may also include, e.g., but may not be limited to, a main memory 408, random access memory (RAM), and a secondary memory 410, etc. The secondary memory 410 may include, for example, (but not limited to) a hard disk drive 412 and/or a removable storage drive 414, representing a floppy diskette drive, a magnetic tape drive, an optical disk drive, a compact disk drive CD-ROM, DVD, BlueRayetc. The removable storage drive 414 may, e.g., but not limited to, read from and/or write to a removable storage unit 418 in a well known manner. Removable storage unit 418, also called a program storage device or a computer program product, may represent, e.g., but not limited to, a floppy disk, magnetic tape, optical disk, magneto-optical device, compact disk, a digital versatile disk, a high definition video disk, a BlueRay disk, etc. which may be read from and written to by removable storage drive 414. As may be appreciated, the removable storage unit 418 may include a computer usable storage medium having stored therein computer software and/or data.

In alternative illustrative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, Flash memory device, SDRAM, and other removable storage units 422 and interfaces 420, which may allow software and data to be transferred from the removable storage unit 422 to computer system 400.

Computer 400 may also include an input device such as, e.g., (but not limited to) a mouse or other pointing device such as a digitizer, touchscreen, and a keyboard or other data entry device (none of which are labeled).

Computer 400 may also include output devices, such as, e.g., (but not limited to) display 430, and display interface 402. Computer 400 may include input/output (I/O) devices such as, e.g., (but not limited to) communications interface 424, cable 428 and communications path 426, etc. These devices may include, e.g., but not limited to, a network interface card, and modems (neither are labeled). Communications interface 424 may allow software and data to be transferred between computer system 400 and external devices. Other input devices may include a facial scanning device or a video source, such as, e.g., but not limited to, a web cam, a video camera, or other camera.

In this document, the terms “computer program medium” and “computer readable medium” may be used to generally refer to media such as, e.g., but not limited to removable storage drive 414, and a hard disk installed in hard disk drive 412, etc. These computer program products may provide software to computer system 400. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an illustrative embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to this data as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another illustrative embodiment, the invention may be implemented using a combination of any of, e.g., but not limited to, hardware, firmware and software, etc.

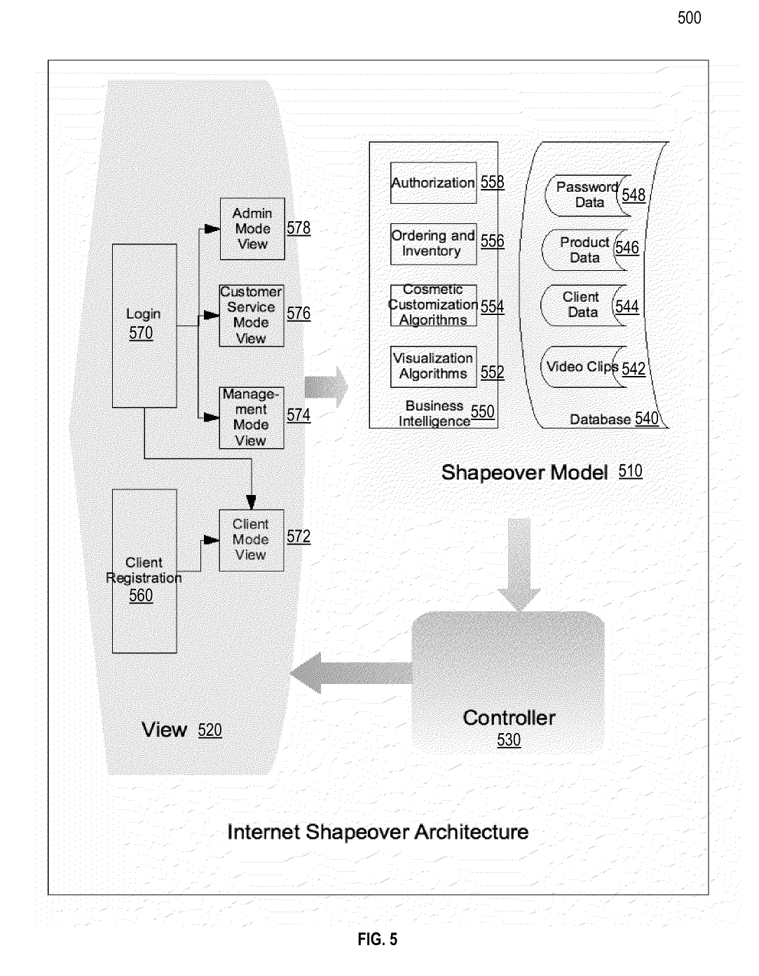

FIG. 5 depicts an illustrative embodiment of an example software design architecture 500 that may be used to implement an embodiment of the present invention. The architecture may follow the standard design pattern of model 510, view 520, controller 530 (MVC) architecture. The architecture 500 may be implemented, for example, as a web application, a client-server application, a distributed application, a peer-to-peer, a software as a service offering, an applet, a plugin, a widget, a mobile phone application, an interactive TV application, etc. This standard design pattern may isolate the business logic from the presentation and input of data.

FIG. 5, item 510, the model, may encapsulate any data that may be required by the system. Such data may include a database 540 to store the data, video clips 542, client data 544, product data 546, and/or password data 548. Client data 544 may contain, e.g., but may be not limited to, client name, client login identification, client shipping address, client preferences, client prior session data, etc. Additional client data may be described below. Product data 546 may contain, e.g., but is not limited to, product name, product description, product manufacturer, etc. Password data 548 may contain information on passwords such as, e.g., but not limited to, encrypted client passwords, corresponding client identification, password reminders, etc.

The model, 510, may also contain any necessary business or domain logic 550 which, in conjunction with raw data, may provide meaningful data to the view 520 for presentation to the user. The business logic 550 may contain, e.g., but is not limited to, visualization algorithms 552, cosmetic customization algorithms 554, ordering and inventory algorithms 556, authorization algorithms 558, etc. When the model 510 changes state, any associated views 520 may be updated with new data.

FIG. 5, item 520, the view, may render data received from the model 510 into a form suitable for user interaction. Multiple views 520 may exist such as, e.g., but not limited to, client registration view 560, login view 570, client mode view 572, management mode view 574, customer service view 576, administrator mode view 578, update password view (not shown), payment view (not shown), etc. Each view may be, for example, a separate web page. The view 520 may be generated via, e.g., but not limited to, Java, XML, HTML or XHTML, etc. for example.

FIG. 5, item 530, the controller, may receive input from a user or from a generated system response. When the controller receives input, the controller 530 may make a call to the model 510. When the model 510 may receive a call from the controller 530, the model 510 state may change. When the state of model 510 may be changed, any associated views 520 may be refreshed with new data. The input to the controller 530 may be in the form of a GET or POST.

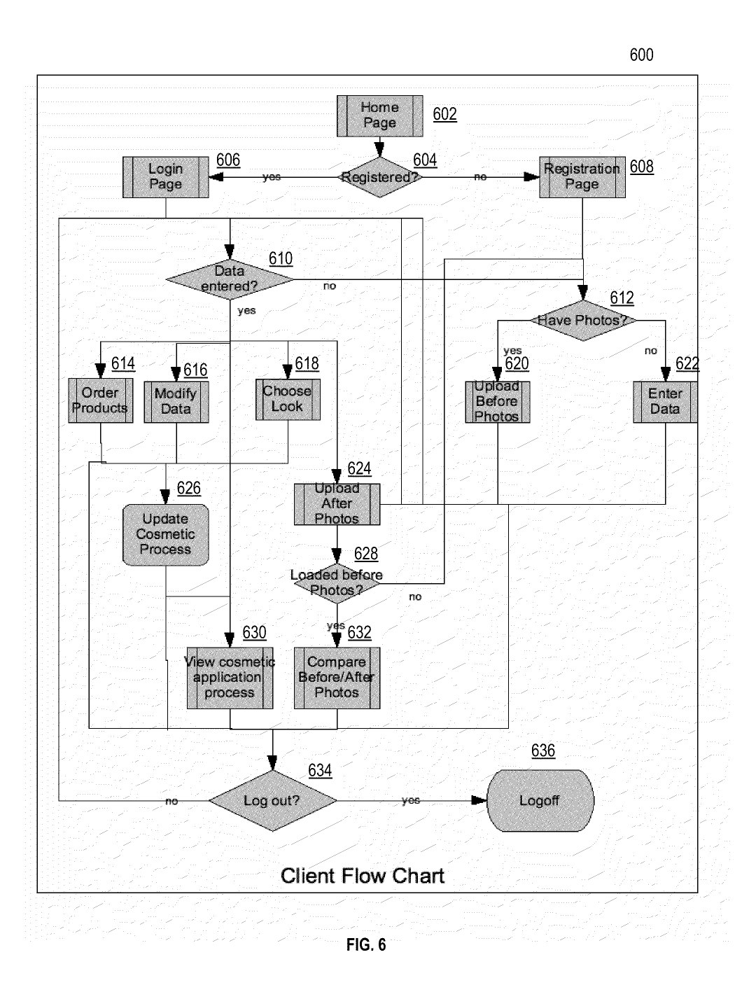

FIG. 6 depicts an illustrative embodiment of a an example control flow diagram 600 for a web based client mode view 572. Flow diagram 600 may begin with 602. At 602, the client, using a standard internet browser (not shown) may initially view a home page. The home page 602, may contain logic to determine if the user may be currently logged into the system. If the user may be currently not logged into the system, the system may determine if the user may be currently registered 604. Alternatively, the home page 602 may also contain views of the registration page 608 and the login page 606. If the user may be not currently a member, the system may display the registration page 608. The registration page 608 may allow the user to create a user name (a unique identifier), enter a password, multiple addresses, preferences, billing information, etc. The login page 606 may allow registered users of the system to login to the system.

From 606, once a user in logged into the system, the application may, for example, flow to 610 to determine if all the required data has been entered. If additional data may be to be entered, the application may flow to 612 to determine, for example, if photos are available and may be uploaded 620 or if other data should be entered 622. From 620 and 622, the system may continue with 624 or 610 and the process may request at least a minimum amount of data from the user for the process to continue. From 610, when sufficient data may be entered, the process may continue, for example, to allow the user to choose a look 618, to modify the previously entered data 616, to order products 614, to compute the Perfect Shape™ makeover process (not shown), etc. If new data may be entered after the process has been completed (e.g., through 614, 616 or 618), the user may be presented with the option to update the Perfect Shape™ makeover process 626.

Once the Perfect Shape™ makeover process may be completed the user may be presented a view of the process 630. Additionally, from 630, 632, 626, 614, 616, 618 the client may be presented with the option to upload post-Perfect Shape™ makeover process photos (e.g., after photos) 624 and if the system determines at 628 that pre-Perfect Shape™ makeover process photos (e.g., before photos) were uploaded 620 then the system may compare before and after the photos 632. The system may allow the user to continue to enter data at 610 until presented with a log out option 634. Once the user logs out, the system may log out the user in 634 and may end his or her session 636.

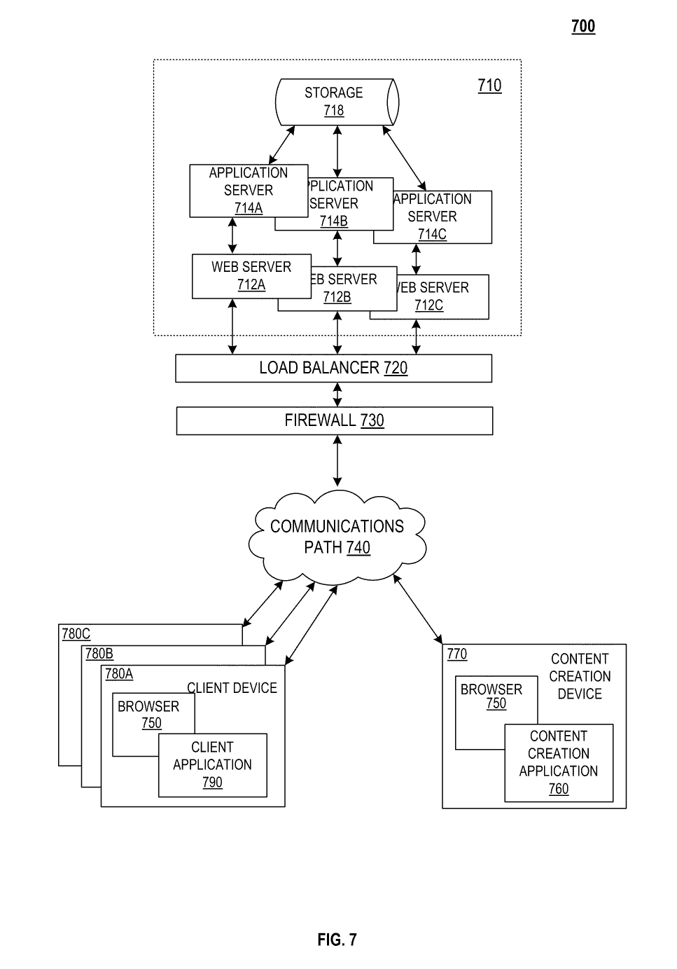

FIG. 7 depicts an example high-level view of an illustrative embodiment of a possible custom Perfect Shape™ instructional cosmetic procedure creation and distribution online system 700 according to an example embodiment of the present invention. An illustrative embodiment of a Perfect Shape™ service provider 710 may provide for a client-server network design with back-end services and processing and may include of one or more web servers 712A, 712B, 712C, etc. (collectively 712), one or more application servers 714A, 714B, and 714C, etc. (collectively 714) and may have a physical or logical storage unit 718. A single web server 712 may directly communicate with any of the application servers 714.

A Perfect Shape™ service provider 710 may create, store, and compress for electronic transmission or distribution Perfect Shape™ instructional content. A Perfect Shape™ service provider 710 may receive and decompress electronic transmissions from clients, customers, content creators, and other interested individuals. The physical or logical storage unit 718 may, for example, store sample video clips, photographs, sketches, audio, text, marketing information, product information, and client data. The servers 712 and 714 may be coupled to client devices 780A-780C and content creation device 770 through a communications path 740 (e.g., but not limited to the internet) via a load balancer 720 and a firewall 730. According to another embodiment (not shown), the custom Perfect Shape™ instructional cosmetic procedure creation and distribution system 700 could be represented by any of a number of well known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) by one skilled in the art could also be used.

According to one embodiment, a content creation device 770 may provide tools for a content creator (not shown) to provide content such as, e.g., but not limited to, video, audio, photographs, textual description, product information, etc, to the system 700 which may be stored in a storage unit 718. The content creation device 770 may be a computing device 400 or any other device capable of interacting with a network such as the communications path 740. The content creation device 770 may contain creation application 760 which may provide a content creator (not shown) the ability to, e.g., access, add, delete, modify, and create content. The content creation application may be proprietary, commercial, or open source software or a combination.

The content creation device 770 may also contain a browser 750 (e.g., but not limited to, Internet Explorer, Firefox, Opera, etc.), which may, in conjunction with web server 712, allow a content creator the same functionality as the content creation application 760. As recognized by one skilled in the art, several content creation devices 770 may exist in system 700.

The Multiple client devices 780A, 780B, 780C, etc., hereinafter collectively referred to as 780, may exist in system 700. Client device 780 may be a computing device 400 or any other device capable of interacting with a network such as the communications path 740. Client device may contain a client application 790. Client application 790, may be proprietary, commercial, or open source software or a combination and may allow a user, client, or customer (not shown) with the ability to create a customized instructional cosmetic procedure. Client device 780 may also contain a browser 750 which may, in conjunction with web server 712, allow a user, client, or customer the same functionality as the client application 790.

System 700 also contains a communications path 740. Communications path 740 may include, e.g., but not limited to, a network, a wireless or wired network, the internet, a wide area network (WAN), or a local area network (LAN). The communications path may provide a communication medium for the content creation device 770, the client devices 780, and one or more servers 712 and 714 through a firewall 730.

In one illustrative embodiment, storage device 718 may include a storage cluster, which may include distributed systems technology that may harness the throughput of, e.g., but not limited to, hundreds of CPUs and storage of, e.g., but not limited to, thousands of disk drives. As shown in FIG. 7, cosmetic content file upload and download operations may be provided via one or more load balancing devices 720. In one exemplary embodiment, the load balancer 720 may include a layer four (“L4”) switch. In general, L4 switches are capable of effectively prioritizing TCP and UDP traffic. In addition, L4 switches, which incorporate load balancing capabilities, may distribute requests for HTTP sessions among a number of resources, such as web servers 712. For this exemplary embodiment, the load balancer 720 may distribute upload and download requests to one of a plurality of web servers 712 based on availability. The load balancing capability in an L4 switch may be currently commercially available.

In one embodiment, the storage device 718 may communicate with web servers 714 and browsers 750 on remote devices 780 and 770 via the standard Internet hypertext transfer protocol (“HTTP”) and universal resource locators (“URLs”). Although the use of HTTP may be described herein, any well known transport protocol (e.g., but not limited to, FTP, UDP, SSH, SIP, SOAP, IRC, SMTP, GTP, etc) may be used without deviating from the spirit or scope of the invention. The client devices 780 and content creation device 770, the end-user, may generate hyper text transfer protocol (“HTTP”) requests to the web servers 712 to obtain hyper text mark-up language (“HTML”) files. In addition, to obtain large data objects associated with those text files, the end-user, through end user computer devices 770 and 780, may generate HTTP requests (via browser 750 or applications 760 or 790) to the storage service device 718. For example, the end-user may download from the servers 712 and/or 714 content such as, e.g., but not limited to, customized instructional cosmetic application videos. When the user “clicks” to select a given URL, the content may be downloaded from the storage device 718 to the end-user device 780 or 770, for interactive access via browser 750, and/or application 760 and/or 790, using an HTTP request generated by the browser 750 or applications 760 or 790 to the storage service device 718, and the storage service device 718 may then download the content to the end-user computer device 770 and/or 780.

### Process for Customizing an Interactive, Instructional Cosmetic Procedure for a Client or Customer

### Example Website Configuration

A website or similar forum may be maintained which may allow access to data for the benefit of both customers and website proprietors. The website or similar forum may be accessed through a personal computer or any device capable of downloading data, such as, e.g., a web-enabled mobile phone. Website proprietors could include, for example, employees of the company that owns the website, software developers, system administrators, website administrators, and professional cosmeticians or anyone authorized to practice the Perfect Shape™ Makeover Process. Particular screens may be restricted or presented depending on who may be accessing the website.

The screens may be presented to the user through the use of a scripting language such as action script, php, Java script, JSP, ASP, dynamic HTML, etc.

Example Initial Home Page

The home page may contain one or more web-enabled logos or brand identifiers representing the company running the website, links to affiliated websites, various products for sale, advertisements, links to beauty blogs, contact information, etc.

The home page may also contain the ability to sign in, login, or to register as a new user. The registration option may request additional data such as, e.g., but not limited to, name, shipping address, billing address, and payment options, these are addressed in greater detail below.

Example Web Login and Setup

I. Example Client Payment Options. A client may access details of the payment screen from any computer or device. The payment screen may be structured and secured using the latest in web security and technology. Payment may be requested from a user, in order to have the system perform the Perfect Shape™ makeover process. Payment may also be needed for purchasing cosmetics from the website. A client may obtain entry into the web site, or similar forum, via a code, which may be paid for and/or obtained from, in an example embodiment, from, e.g., but not limited to:
1. Phone call with telemarketer
2. Web site payment and direct entry (easiest for client and company)
   i) Credit or debit card (e.g., but not limited to, Mastercard, Visa, American Express, etc.)
   ii) On-line pay service (e.g., but not limited to, PayPal, Google Checkou, etc.)
   iii) Coupon code
   iv) Personal check
   v) Wire transfer
3. Retail store
4. Partnership marketing arrangement

II. Example Registration Data. Clients may need to initially register to use the web page or similar forum. Several pieces of information may be required. Mandatory information may include:
1. Full name
2. Shipping address
3. Billing address
4. Email address
5. Phone number
6. Login identification (ID) ((A standard process may be implemented to ensure a system unique ID)
7. Password

Optional registration information may include:
1. Password reminder
2. Client payment options (as discussed above)
3. Additional phone numbers
4. Additional shipping addresses
5. Change and modify a list of past ordered or used products
6. Favorites

III. Example Input Data. To begin the process, the client may be presented with a series of questions similar to the following list via, for example, multiple choice, entering one or more numbers, or short answer.

i. Example Display Device (e.g., Monitor) Calibration

Display device (e.g., monitor) Calibration. To match best the initial foundation color, the display device (e.g., monitor) may be calibrated so that what the client sees on the screen may be as close as possible to the standard defined colors. Different choices for calibrated colors of common household items may be presented on the display device (e.g., monitor). Examples include Coca-cola's red, Pepsi-cola's blue, Cheer laundry detergent's blue, Cascade dishwashing detergent's green, the $5 bill's green background surrounding the Lincoln Memorial on the reverse, and so on. For each item that the client may be willing to input, 12, for example, different hues of that color may be shown on the monitor, and the client may select which one may be closest. Another iteration of 12, for example, colors close to the hue may be shown and selected from as well. This calibration can also help optimize the future display of the client's options for the different Shapeover™ possibilities.

ii. Example Personal characteristics

Help for the client may be available at every question to describe why this information may be relevant. For example, if the client requests help for the questions regarding height and weight a response may discuss how the calculation of the height and weight may, for example, emphasize or deemphasize horizontal lines.

Facial skin tone. The client may enter a value in response to a prompt as to his or her facial skin tone. One method may include displaying Different colored areas (e.g., squares, circles, etc.) to the client (e.g., on monitor or display device). The client may be encouraged to get as much natural light and the best, most accurate monitor possible, and then select the color that most closely matches his or her facial skin tone. The client can, for example, hold up a handheld mirror in front of half the monitor and compare his or her skin color to that on the screen. This choice may determine which set of close shades of makeup foundation may be chosen for to obtain the Perfect Match.™ The foundation shades may also be used to calibrate the display device (e.g., monitor) so the client can Match Your Friends™ accurately even if she doesn't have the range of foundation colors of his or her friends or even any more of the foundation.

Race/ethnic origin. The client may optionally enter a value as to his or her racial or ethnic origin. A client's ancestry may impact which of the known problems questions that are asked, though political correctness must be maintained.

Eye color. The client may enter a value as to his or her eye color. Brown, blue, and green may follow the standard process while hazel eyes may offer difficulty. If hazel, for the default “Natural” optimized look. Warm tones in which the brown exceeds the yellow, the eyelid color may be a light copper. Warm tones, in which the yellow exceeds the brown, the eyelid color may be light yellowish tinted light copper. Hazel eyes that are cool tone, in which the dominant colors are blue and green, the eyelid color may be frosty or light lavender.

Facial measurements. The client may enter values for measures certain key facial measurements. These key facial measurements are shown, for example, in illustrative embodiment FIG. 1.

Some measurements may include, e.g., but are not limited to, face height, face width at cheekbones, nose height, forehead height, chin height, lips height, lips width, philtrum (between top of upper lip and bottom of nose) height, sublabial (below lower lip to chin) height, eye height, eye width, eye shadow height, brow up width, brow up diagonal length, brow down diagonal length, brow tip to hair height, brow tips width, face width at lips, face width at temples, and/or neck corner to collarbone height, etc.

Additionally, the Client may also select features most like the client's from an assortment of noses, ears, eyes, lips, etc. This may be analogous to police using software to build a composite sketch of a suspect by selecting the best match from various candidate features.

Body measurements. The client may enter values for certain body measurements. These body dimensions may include, e.g., but not limited to, height and weight.

Known problems. Clients may also enter personal features that they consider to be problem areas requiring special attention. These include, e.g., but are not limited to:
1. The appearance of wrinkles (from, e.g., age or sun exposure)
2. One eye higher than the other
3. Crooked face for example, the line connecting eyes at different angle than mouth (e.g., Ronald Reagan, Dick Cheney)
4. Abundance of loose skin (e.g., extra, sagging skin below the jaw on the neck (turkey neck))
5. Non-symmetrical features (e.g., different size eyes, different color eyes (hetrochromia), misaligned ears, nostrils not the same size or shape, etc.). Called hetrochromia

Type of look desired. Clients may also enter a particular type of look. The fundamental assumption here is that the client is always right. If the client does not like the natural look, there are other possibilities. Also, different looks may be appropriate for different situations. Some of these examples may include, e.g., but are not limited to:
1. Natural yet optimized, the default and our specialty
2. Quick application
3. Nightlife
4. Glamorous
5. Innocent
6. High fashion, with colors in style this season
7. Stage (very heavy and noticeable)
8. Accenting eye (iris) color
9. Goth
10. Sexy
11. Professional interview
12. Professional daily wear
13. Looks named after Places, Hollywood, Paris, Milan, or Rio de Janeiro, for example
14. Looks named after makeup artists, for example, Bobbi Brown and Michael Maron. The computer system becomes a distribution channel for these artists and perhaps their product companies, but clients would always have to use our foundation.

There may be a description of each type of look right next to the choice on the screen. If the client can't decide on which one from the descriptions, 2 or 3, for example, can be selected and differences may be shown visually. Also, several looks may be combined in different ratios.

“Glamorous,” for example, may have brighter colors and may be more noticeable, day or night, versus “Nightlife” which may be optimized to look better in the night's incandescent and fluorescent lighting, for example.

“Natural,” for example, may take more time to get the details right, especially around the eyes. “Quick application” may remove some of the more time consuming steps.

Time available. Clients may also enter the amount of time that he or she has available for cosmetics application. This may help determine the best look for everyday work if the individual wants to dedicate only, for example, 10 minutes for cosmetics application. This may require modeling of how long it takes to prepare and do various cosmetic application steps. This may focus on the areas the client is most sensitive with.

Geographic location. Clients may also enter their location which may also be known from the shipment address. However, a question may be asked regarding travel, for example, to the beach, in which higher SPF products may be recommended, or a foreign country in which different cosmetics styles would be in fashion unless the client wants to look like a tourist.

Time of year. Clients may also enter a particular time of year for cosmetics application. For example, holidays. During the training session the time of year may be known. The time of year during the last training session may be tracked and, if different from the current interaction, potential differences may be noted to the individual about the different seasons.

Socio-Economic Class of Viewer. Clients may enter a particular socio-economic class. This may be important, for example, if someone is selling or speaking to the poor or to the upper class and wants to look the most attractive to that particular class, different versions of Shapeovers may be appropriate. Data on this may be collected from reviews by zip code.

Type of lighting. The client may also enter a particular type of lighting. If, for example, the client may be attending an event indoors with incandescent or fluorescent lighting and really wants to look the best, adjustments may be needed compared to being outside.

Clothes color. The client may enter particular clothes coloring. The system may direct the client on differences between different colors of clothes, especially blouses and coats.

iii Example Alternate Source Data

To accurately map the face and provide instructions to the client, input data may be received from sources such as, but not limited to, photographs, measurements, feature selection, and/or three-dimensional scanning, or similar technology. Similar data can be input on, e.g., but not limited to, the neck, torso, and/or the entire body, for example. The same process could be done of inputting the data on the current physical shape, performing calculations on how to “trick” the viewer's eye into viewing the body in its most positive light, and then developing the instructions to get that optimal look. The right clothes, shoes, and accessories, for example, to obtain the optimal shape and look could be prescribed for the client.

Client furnished photographs. Requirements for photographs may include, e.g., skin freshly washed with no makeup remaining, camera straight on and level with the face, not higher nor lower, and or lighting positioned so no significant shadows are visible. Also required, a size calibration device held and therefore visible in the picture; possibilities include, but are not limited to, a quarter, dollar bill, or ruler. This may enable the size of the face to be replicated exactly and the Highlight and Shadow strokes calculated as well. It may also enable links to other sites that, for example, sell eyeglasses, earrings, nose/lip/skin rings, etc. These products may then be shown to the client with the exact dimensions relative to the client's face.

Several different photographs with the client in different poses may be required in an example embodiment. Examples may include, e.g., but are not limited to:
1. Hair in its preferred style and color for the instructional video training
2. Not smiling, natural “face at rest” look. with hair pulled back, away from the face, and above ears. This may enable exact facial measurements to be calculated as well as different hair styles and even hair colors to be considered.
3. Smiling, with the most attractive smile the individual knows how to do, hair pulled back, away from the face, above ears. This may enable additional facial measurements to be calculated.

Example Three-dimensional scanning or similar technology. This option may be available, for example, when company stores are opened or perhaps counters placed in larger department stores. A Three-dimensional scanner or similar device may map, for example, the entire face and neck and calculations, including Arc Lines, would be done from the rather dense mapping. The scanning may be completely safe for clients and store employees.

Example Computer Processing

The answers from the client questionnaire may be used for computing the custom cosmetics application process. The data acquired on, for example, personal characteristics and known problems such as age or sun exposure, may cause wrinkle covering steps to be included at the beginning of the cosmetics application process, as well as specific instructions when, for example, the eye and neck shadow applications are described.

Further, the type of look desired may cause substantial changes to be computed in the type and amount of cosmetics prescribed.

The data acquired from the alternate sources, such as, for example, but not limited to, scanned photos, client measurements, or three-dimensional scan may also be used for computing the custom application process, etc.

Facial Shape calculations. The following shaping processes may be applied when computing the cosmetics application process. The assumption may be that the Oval Face may be the ideal face. (The following shaping processes are from Salon Fundamentals 638-640 (Pivot Point Intl. inc. 3d ed. 2000), a textbook from a beauty college, which is incorporated herein by reference in its entirety)
(1) Round, fuller. For example, shadow may be applied on the sides to make the face appear more slender.
(2) Oblong, long and narrow. For example, visually shorten the face by shadowing under the chin and horizontally at the hairline. Horizontal lines may be emphasized wherever possible, in brow shape, cheek color and lip shape. Highlighting may be used to add visual width when possible.
(3) Pear, with narrow forehead and wide jaw line. For example, add width to the forehead via highlighting. Contour to reduce width at the bottom of the face.
(4) Square, with broad, straight forehead and hairline, and a broad jaw line. For example, this effect can be very angular and almost masculine. Contouring can be done to soften the angularity and reduce the width of the top and bottom of the face.
(5) Heart, with wider forehead and narrow jaw or chin line. For example, forehead width can be minimized by shadowing the forehead while the jawline can be visually widened via highlighting.
(6) Diamond, with prominent width at the cheekbones contrasting with narrow forehead and chin/jaw areas. For example, width through the cheekbones may be minimized with contouring and the jaw and forehead can be made to look wider with highlighting.

Facial Portion Calculations may include, e.g., but are not limited to:
(1) Facial vertical proportions: calculations may be made to determine, for example, if the Eyes/Nose/Chin Tip are in ⅓, ⅓, ⅓ proportions.
(2) Eyes horizontal proportions: calculations may be made to determine, for example, if the five parts of outside eye/eye/distance between eyes/other eye/and other outside eye each ⅕ the distance going across.
(3) Mouth: calculations may be made to determine, for example, if the mouth is ½ way between the nose tip and the chin tip.

Feature location symmetry: Calculations may be made to determine, for example, eyes, ears, and brows are in the same location on both sides of the face.

Feature symmetry: calculations may be made to determine, for example, if the eyes, brows, ears, and cheekbones on one side of the face are the same shape on the other side of the face.

Arc Line calculations: Once client data is inputted, Arc Line locations may be calculated. The Arc line calculations may locate precisely where Highlights and Shadows may be applied. Arc Lines may be more difficult to calculate on some client input such as client measurement data and photographs, but calculations to determine the Arc Lines can still be created to locate where the cosmetics should be applied.

Feature Optimization calculations include, e.g, but are not limited to:
(1) Eyes: Almonds, Round, Deep Set, Small, Hooded, Close set, Wide set, Droopy, Protruding, Asian (Cindy Crawford, Basic Face 74-75 (Broadway 1996), which is hereby incorporated in its entirety by reference)
(2) Eyes: Close set, Wide set, Prominent, Round, Deep set, Down slanting, Hooded, Small, Asian (Michael Maron, Makeover Miracles: A Before-and-After Guide to Corrective Makeup, Cosmetic Surgery, and Anti-Aging Strategies 46-48 (Crown 1st ed. 1994), which is hereby incorporated in its entirety by reference)

Using the collected data, computations may be done to customize the set of instructions for applying the cosmetics to achieve the optimal look. The computations may be done, for example, in an expert system in which nonlinear calculations can be processed. The following may be an example hierarchy, the desire for a Glamorous look may take precedence over Feature Symmetry, as the Glamorous' desire for heavier looking makeup may be weighed more heavily than the Feature Symmetry's requirement to highlight the right eye so it appears larger and closer in size to the left eye.

As the process is being computed, the hierarchy and the interaction among its levels may need to be internally tested and continually improved and refined until the process is complete and an optimal look and proposed plan is presented to the client. An example hierarchy from most heavily weighed to least may include, e.g., but is not limited to: Type of Look desired, Facial shape, Facial proportion, Feature location symmetry, Feature symmetry, and finally Feature optimization.

Example Review of Example Proposed Shapeover™ Look, and Interaction

Once the data is collected and the calculations and computations completed, the face with the proposed plan of cosmetics applied may be shown to the Client. At this point the system may enter a decision tree. If the client approves the look, then the system may skip to the output of customized instructions step. If the client does not approve, then the system may then develop and display alternative looks. These alternatives can be initiated by the client by, for example, choosing a different type of look and/or clicking on individual features and selecting how he or she would like change the cosmetic application's appearance. The application appearance can be changed by, for example, location, color, and/or intensity.

The client may have multiple sessions for each type of desired look. Each look may have its own process and content delivery system.

In one illustrative embodiment, the client may also ask for feedback on the alternatives from, for example, friends via email links, Facebook, MySpace, other social networking sites, and/or fellow clients with similar characteristics and preferences. Client panels could be arranged, perhaps anonymously, in which, for example, clients, non-clients, and/or members of the opposite sex (especially for the “Sexy” and “Professional” looks), can review each others' alternatives. Choices can be tracked and recommendations developed based on those choices in a manner similar to John Malloy, Dress for Success (Grand Central Publishing 1988) and John Malloy, New Women's Dress for Success (Grand Central Publishing 1996) which are incorporated herein by reference in their entirety.

After feedback is obtained, changes in the look and/or feature treatment may be made again as described above and then feedback may be obtained again. The system, e.g., computer, returns to the “client approval step” for approval of a number of alternatives that may be displayed on the screen.

A person reviewing a look may have the option to save the look as a favorite and may, using that look as a style, perform the Shapeover™ process to achieve that desired look.

The system collects data about feedback and feature decisions and improves its future recommendations. Improvements include, but are not limited to, new products, new colors/styles, and new techniques. The system may quickly adapt to cultural fads, such as, e.g., Sarah Palin's glasses and look, eponymous hairstyles and looks, Farah Fawcett's feathered shag hairstyle, and Dorothy Hamill's wedge hairstyle.

Example Output of the Customized Instructions

Once the desired, customized Shapeover™ picture has been selected, the resulting Shapeover™ set of instructions may be computed, calculated, etc. The training method may be determined by, for example, the contents of the data, the data input method, and or as well as the delivery method. For example, the training method may be in the form, for example, of an instructional video which may be provided via the internet through streaming video or may be in the form of, e.g., but not limited to, a physical DVD, BLUERAY, high definition interactive application, or other media, etc., which may be provided to the customer via post.

Client furnished photographs may have had substantial pattern recognition and calculations completed, including on Arc Lines. These calculations may be used to pull, for example, but not limited to, video clips, etc., which may need to be modified, and compiled to show how the makeup is applied and the results after each application step. The final photo may be with the cosmetics applied to, for example, the Non-smiling photograph. The Hair photo can be used, for example, to try out different hair shapes and colors on the face with the cosmetics applied, while the Smile photograph can be computed with the makeup applied as well. The photographs may be synchronized with each other. A visual depiction of the client through photograph, video, or other means may be supplied to show the client not only the completed natural look but also various other looks (e.g., professional, goth, glamorous, etc).

Measurements and Feature Selection, for example, may be used to determine a composite face on which the cosmetics may be applied. Video Clips, for example, may be pulled from a library based on the measurements, modified if needed, and compiled to show how the Shapeover™ process is done. A composite face with the makeup on may be shown as well.

A three-dimensional scanner or similar device may enable Arc Lines to be calculated and strokes of cosmetics located precisely. The monochrome scan and the selection of the skin tone may enable a composite face to be built. Video Clips, for example, may be pulled from a library based on the calculated measurements, the Clips modified if needed, and compiled to show how the Shapeover™ process is done. A composite face with the makeup on may be shown as well.

The following include some examples of various delivery options for the customized Shapeover™

i. Example Web Streaming Video and Audio.

The client may see and hear their instructions via the web, most likely on the same area that the data and photos were input. The benefits can include but are not limited to: fast delivery; least cost delivery for the company; possible requirement for continued club membership; continued access enables ongoing improvements, additions to product line, different looks and styles, etc. over time, as well as targeted marketing. A laptop computer with wireless Internet, for example, would be ideal for convenience, as the client could place it on the vanity and go over step by step how to put on the cosmetics.

ii. Example Printed Text and Pictures.

Text & pictures could be delivered or printed, for example, via internet site, email, or even postal mail. Hardcopy instructions would enable the client, for example, to bring in booklet and pictures into the room where she may put on the makeup, with no technology needed. The benefits can include but are not limited to: worldwide access for clients; and ongoing improvements possible. Text and pictures could also be delivered personally where the client is at a retail store or via machine where the client is using an automated kiosk machine.

iIi. Example DVD or Other Audio/Video Media

The client could view a DVD or other audio/video media on her display device (e.g., TV or monitor). The benefits can include but are not limited to: convenient for initial and subsequent watching, method is similar to how other firms deliver media, and far away from the vanity where the cosmetics are actually applied. However, having the client watch a step on the TV and walk back to her bathroom to apply the makeup, then coming back to the TV, going back to the vanity, and repeating this a dozen times could result in more returns; no revision possibilities unless another DVD is compiled and shipped, perhaps at the 1 year anniversary or the new DVD is purchased. DVD or other media could also be delivered personally where the client is at a retail store or via machine where the client is using an automated kiosk machine.

Pictures Taken Afterwards for Review and Feedback

Once the cosmetics application is completed, real “After” photos may be taken and shared with many of the same people who examined the proposed different looks in the “ask for feedback” step described above. Multiple choice input, for example, may be enabled for comments on the appearance of various features, such as “Eye Shadow: too little, too much, or just right? “Right color?” This may enable adjustment of the individual's cosmetics application process as well as the computerized rules, ever improving the rule set.

Various additional features may be included with the illustrative embodiment of the present invention such as, e.g., the following patents, U.S. Pat. No. 7,079,158 and U.S. Pat. No. 6,810,130, which are incorporated in their entirety herein by reference.

While various embodiments of the present invention have been described above, it should be understood that they have been presented by way of example only, and not limitation. Thus, the breadth and scope of the present invention should not be limited by any of the above-described illustrative embodiments, but should be defined only in accordance with the following claims and their equivalents. While this invention has been particularly described and illustrated with reference to a preferred embodiment, it may be understood to those having ordinary skill in the art that changes in the above description or illustrations may be made with respect to formal detail without departing from the spirit and scope of the invention.

What is claimed is:

1. A cosmetic instruction method comprising:
receiving by at least one computer at least one of face or body data;
receiving by the at least one computer preference data;
calculating by the at least one computer Arc Lines of said face or body data;
analyzing by the at least one computer at least one of environmental, socio-economic, or seasonal factors;
determining by the at least one computer at least one optimal cosmetic application procedure; and
providing by the at least one computer said optimal cosmetic application procedure.

2. The cosmetic instruction method according to claim 1, further comprising:
receiving by the at least one computer at least one facial feature to deemphasize.

3. The cosmetic instruction method according to claim 2, wherein the at least one facial feature to deemphasize includes at least one of:
a nose, eyes, lips, mouth, eyebrows, eyelashes, eyelids, ears, skin tone, forehead, a wrinkle, a wart, freckles, loose skin, a non-symmetrical feature, a crooked face, or one eye higher than the other.

4. The cosmetic instruction method according to claim 1, further comprising:
receiving by the at least one computer at least one facial feature to emphasize.

5. The cosmetic instruction method according to claim 4, wherein the at least one facial feature to emphasize includes at least one of:
a nose, eyes, lips, mouth, eyebrows, eyelashes, eyelids, ears, skin tone, freckles, or forehead.

6. The cosmetic instruction method according to claim 1, further comprising:
calibration of a display device.

7. The cosmetic instruction method according to claim 1, wherein said receiving said face or body data comprises receiving at least one of:
skin tone, ancestry, eye color, age, or hair color.

8. The cosmetic instruction method according to claim 1, wherein said receiving said face or body data comprises receiving a measurement of at least one of:
face height, face width at cheekbones, nose height, forehead height, chin height, lips height, lips width, philtrum height, sublabial height, eye height, eye width, eye shadow height, brow up width, brow up diagonal length, brow down diagonal length, brow tip to hair height, brow tips width, face width at lips, face width at temples, or neck corner to collarbone height.

9. The cosmetic instruction method according to claim 1, wherein said receiving said face or body data comprises receiving a measurement of at least one of:
height, age, or weight.

10. The cosmetic instruction method according to claim 1, wherein said receiving said preference data comprises receiving at least one of:
a type of look, time available, a geographic location, a time of year, a socio-economic class, a type of lighting, or a clothes color.

11. The cosmetic instruction method according to claim 10, wherein said receiving said type of look comprises receiving at least one of:
natural, quick application, nightlife, glamorous, innocent, high fashion, seasonal style, stage, accenting eye color, goth, sexy, professional interview, professional daily wear, cat eye, a location style, or an personality style.

12. The cosmetic instruction method according to claim 11, wherein said receiving said location style comprises receiving at least one of:
Hollywood, Paris, Milan, London, New York, San Francisco, Tokyo, Bombay, Munich, Vienna, or Rio de Janeiro.

13. The cosmetic instruction method according to claim 11, wherein said receiving said personality style comprises receiving at least one of:
Bobbi Brown or Michael Maron.

14. The cosmetic instruction method according to claim 1, wherein said providing comprises at least one of:
displaying, transmitting over a network, delivering a program product using a postal carrier, or hand delivery.

15. The cosmetic instruction method according to claim 1, wherein said providing said optimal cosmetic application procedure comprises providing at least one of:
content, video, audio, text, pictures, sketches, or audio/video media

16. The cosmetic instruction method according to claim 1, further comprising:
receiving at least one of a photograph, a video clip, or a sketch.

17. The cosmetic instruction method according to claim 1, wherein said receiving said at least one of client face or body data comprises receiving data from at least one of:
a measuring device, a three-dimensional scanner, telephonically, the internet, a website, a photograph, a video, a picture, or a sketch.

18. The cosmetic instruction method according to claim 1, further comprising:
receiving a photograph;
presenting photograph to at least one individual; and
receiving data from said at least one individual.

19. The cosmetic instruction method according to claim 1, further comprising:
providing at least one proposed visual depiction of applied cosmetics; and
requesting and receiving approval or disapproval data.

20. A cosmetic instruction system comprising:
a processor adapted to:
receive at least one of face or body data;
receive preference data;
calculate Arc Lines;
analyze at least one of environmental, socio-economic, or seasonal factors;
determine at least one optimal cosmetic application procedure; and
provide said optimal cosmetic application procedure.

21. A machine-readable medium that provides instructions, which when executed by a computing platform, causes said computing platform to perform operations comprising a method for creating cosmetic instructions, the method comprising:
receiving at least one of face or body data;
receiving preference data;
calculating Arc Lines;
analyzing at least one of environmental, socio-economic, or seasonal factors;
determining at least one optimal cosmetic application procedure; and
providing said at least one optimal cosmetic application procedure.
